(19) United States
(12) Patent Application Publication
(10) Pub. No.: US 2005/0180668 A1
(43) Pub. Date: Aug. 18, 2005

(54) Bearing unit, and motor and electronic equipment, both equipped with the bearing unit

(75) Inventor: Kenichiro Yazawa, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/047,659

(22) Filed: Feb. 2, 2005

(30) Foreign Application Priority Data
Feb. 13, 2004 (JP) P2004-037385

(51) Int. Cl. F16C 29/06; F16C 32/06

(52) U.S. Cl. 384/100; 384/107

(57) ABSTRACT

In the present invention, a bearing unit comprises a shaft, a radial bearing for supporting a peripheral rotation direction of the shaft, a thrust bearing for supporting one end of the shaft in a thrust direction, a housing having the radial bearing and the thrust bearing, both arranged therein, and being formed in a structure being sealed except for a shaft insertion hole, through which the shaft is inserted, and a viscous fluid to be filled in the housing, and the housing is provided with a locking portion for preventing shaft slip-out on an inner surface side thereof, which is a peripheral portion of the shaft insertion hole, in a state of abutting a part of the shaft. This arrangement makes it possible to reduce the length of the bearing unit in its shaft direction and to enhance versatility and selectivity of the bearing unit.

### CROSS REFERENCES TO RELATED APPLICATIONS

The present document is based on Japanese Priority Document JP 2004-037385, filed in the Japanese Patent Office on Feb. 13, 2004, the entire contents of which being incorporated herein by reference.

### BACKGROUND OF THE INVENTION

1. Field of the Invention

The present invention relates to a bearing unit supporting a rotation shaft rotatably, or supporting a rotation body rotatably to a shaft, and a motor and electronic equipment, both equipped with the bearing unit.

2. Description of Related Art

As a bearing unit supporting a rotation shaft rotatably, a bearing unit constituted as shown in FIG. 21 is conventionally known.

A bearing unit 100 shown in FIG. 21 is one supporting a rotation shaft 101 rotatably, and is equipped with a radial bearing 104 for supporting the rotation shaft 101 in its peripheral rotation direction, a space forming member 119 formed integrally with a thrust bearing 110 supporting one end side in a thrust direction of the rotation shaft 101 and a housing 105 housing the radial bearing 104 and the space forming member 119.

In the bearing unit 100, the radial bearing 104 constitutes a fluid dynamic bearing together with a lubricating oil being a viscous fluid filled in the housing 105, and dynamic pressure generation grooves 111 for generating a dynamic pressure are formed on an inner peripheral surface, in which the rotation shaft 101 is inserted.

The space forming member 119 provided on one end side in the thrust direction of the rotation shaft 101 is formed to enclose a lower part of the rotation shaft 101, namely one end on the side to be sealed, as shown in FIG. 21. The space forming member 119 is, for example, formed of a synthetic resin. A lubricating oil is filled around a bearing supporting portion 102 of the rotation shaft 101 on the inside of the space forming member 119.

In the central part of a bottom surface on an inner surface side of the space forming member 119, the thrust bearing 110 supporting the bearing supporting portion 102 rotatably is integrally formed. The bearing supporting portion 102 is provided on the one end side of the rotation shaft 101, which is supported by the radial bearing 104, in the thrust direction. The space forming member 119 is made of the resin and is used as the thrust bearing 110 commonly. The thrust bearing 110 is formed as a pivot bearing supporting the bearing supporting portion 102 of the rotation shaft 101 at a point. The bearing supporting portion 102 is formed in a shape of a circular arc or a shape having a tapering tip.

The housing 105 accommodating therein the radial bearing 104 and the space forming member 119 is shaped to accommodate the radial bearing 104, which is formed in the shape of a cylinder, to enclose the radial bearing 104 therein, as shown in FIG. 21. The housing 105 is a member formed by being integrally molded with a synthetic resin.

The housing 105 is composed of a housing main body 106 shaped in a cylinder, a bottom sealing portion 107 formed integrally with the housing main body 106 to constitute one end side portion thereof for sealing the end side of the housing main body 106, and an upper sealing portion 108 formed integrally with the housing main body 106 to constitute another end side portion of the housing main body 106. A shaft insertion hole 109 is provided in the central part of the upper sealing portion 108. Into the shaft insertion hole 109, the rotation shaft 101, which is rotatably supported by the radial bearing 104 accommodated in the housing 105, is inserted.

The housing 105 configured as described above is integrally formed by arranging the radial bearing 104 on the inner peripheral side of the housing main body 106 by performing the outsert molding using a synthetic resin material to surround the cylinder-shaped radial bearing 104 and the space forming member 119.

The bearing supporting portion 102 of the rotation shaft 101 on the one end side is supported by the thrust bearing 110, and the outer peripheral surface of a shaft main body 103 is supported by the radial bearing 104. Furthermore, the rotation shaft 101 is supported by the housing 105 with the side of an attachment portion 120 formed on the other end side protruding from the shaft insertion hole 109 formed on the upper sealing portion 108 of the housing main body 106.

Moreover, a shaft slip-out preventing groove portion 116 is formed between the bearing supporting portion 102 and the shaft main body 103 in the rotation shaft 101. An annular washer 115 as a shaft slip-out preventing member is provided on the space forming member 119 so as to correspond to the slip-out preventing groove portion 116. The washer 115 prevents the rotation shaft 101 from slipping out of the housing 105. The washer 115 is pressed by the bearing supporting portion 102 of the rotation shaft 101 to bend in the thrust direction, and thereby the bearing supporting portion 102 is inserted into the shaft slip-out preventing groove portion 116 to be attached.

Now, the shaft insertion hole 109 is formed to have an inner diameter larger than the outer shape of the shaft main body 103 in some degree in order that the rotation shaft 101 inserted into the shaft insertion hole 109 may rotate without contacting with an inner peripheral surface of the shaft insertion hole 109 slidably. In this case, the shaft insertion hole 109 is formed to have a gap 112 of a space x1 sufficient for preventing leakage of a lubricating oil 113 filled in the housing between the inner peripheral surface of the shaft insertion hole 109 and an outer peripheral surface of the shaft main body 103 from the inside of the housing 105.

A tapered portion 114 is formed on an outer peripheral surface of the rotation shaft 101 opposed to the inner peripheral surface of the shaft insertion hole 109. The tapered portion 114 inclines in a manner of enlarging the gap 112 formed between the outer peripheral surface of the rotation shaft 101 and the inner peripheral surface of the shaft insertion hole 109 toward the outside of the housing 105. The tapered portion 114 forms a pressure gradient in the gap 112 formed between the outer peripheral surface of the rotation shaft 101 and the inner peripheral surface of the shaft insertion hole 109, and a force drawing the lubricating oil 113 filled in the housing 105 into the inside of the housing 105. Because the lubricating oil 113 is drawn in the inside of the housing 105 at the rotation of the rotation shaft 101, the lubricating oil 113 surely permeates the dynamic pressure generation grooves 111 of the radial bearing 104 made as a fluid dynamic bearing to generate a dynamic pressure. Thereby, a stable support of the rotation shaft 101 is realized, and the leakage of the lubricating oil 113 filled in the housing 105 can be prevented.

The bearing unit 100 configured as shown in FIG. 21 exposes the rotation shaft 101 only at one end on the side of the shaft insertion hole 109, and covers the whole bearing unit 100 by the housing member seamlessly except for a small gap of the shaft insertion hole 109. Consequently, the bearing unit 100 can prevent the leakage of the lubricating oil 113 to the outside of the housing 105. Moreover, because a communicating portion to the outside is only the gap of the shaft insertion hole 109, the scattering of the lubricating oil due to an impact can be prevented. Furthermore, the bearing unit 100 can prevent the rotation shaft 101 from falling off from the housing 105 by the washer 115.

However, because in the above-mentioned bearing unit 100, the washer 115 functioning as the shaft slip-out member is provided on the side of the bottom sealing portion 107, or the side of the sealing portion of the housing, and the bearing unit 100 is provided with the space forming member 119 for providing the washer 115, it is difficult to reduce the length of the bearing unit 100 in the shaft direction thereof.

Moreover, as another bearing unit for rotatably supporting a rotation shaft, one configured as shown in FIG. 22 is known.

The bearing unit 130 shown in FIG. 22 rotatably supports the rotation shaft 131. The bearing unit 130 is provided with a radial bearing 134 for performing the supporting of the rotation shaft 131 in the peripheral rotation direction thereof, a thrust bearing 140 for supporting one end of the rotation shaft 131 in a thrust direction, and a housing 135 accommodating the radial bearing 134 and the thrust bearing 140.

In the bearing unit 130, the radial bearing 134 constitutes a dynamic pressure fluid bearing together with a lubricating oil being a viscous fluid filled in the housing 135, and dynamic pressure generating grooves 141 for generating dynamic pressures are formed on an inner peripheral surface, in which the rotation shaft 131 is inserted.

The housing 135 accommodating the radial bearing 134 and the thrust bearing 140 is composed of, as shown in FIG. 22, a housing main body 136, which is shaped in a cylinder, a bottom sealing portion 137 constituting one end side portion formed integrally with the housing main body 136 for sealing the one end side of the housing main body 136, and an upper sealing portion 138 formed on the opened other end side of the housing main body 136.

A shaft insertion hole 139, through which the rotation shaft 131 supported rotatably by the radial bearing 134 accommodated in the housing 135 is inserted, is formed in the central part of the upper sealing portion 138. The thrust bearing 140 for rotatably supporting a bearing supporting portion 132 formed at the end in the thrust direction of the rotation shaft 131 supported by the radial bearing 134 is provided on an inner surface side of the bottom sealing portion 137 of the housing main body 136.

The thrust bearing 140 is formed as a pivot bearing supporting the bearing supporting portion 132 of the rotation shaft 131 at a point. The bearing supporting portion 132 is formed in a circular arc or a tapered tip.

After the radial bearing 134, the thrust bearing 140 and the rotation shaft 131 have been attached on the housing main body 136, the upper sealing portion 138 is welded. Thereby, the housing 135 configured as described above is integrally formed.

The rotation shaft 131 is supported by the housing 135 in a manner such that, the bearing supporting portion 132 on the one end side thereof is supported by the thrust bearing 140, the outer peripheral surface of the shaft main body 133 is supported by the radial bearing 134, and the side of an attachment portion 150 provided on the other end side protrudes from the shaft insertion hole 139 formed in the upper sealing portion 138 of the housing 135.

Moreover, in the rotation shaft 131, a groove portion 146 for shaft slip-out preventing member is formed between the bearing supporting portion 132 and the shaft main body 133. An annular washer 145 as a shaft slip-out preventing member is provided to the bottom sealing portion 137 correspondingly to the shaft slip-out preventing groove portion 146. The washer 145 prevents the rotation shaft 131 from slipping out of the housing 135. The washer 145 is pressed by the bearing supporting portion 132 of the rotation shaft 131 to be bent into the thrust direction. Thereby, the washer 145 makes the bearing supporting portion 132 be inserted, and consequently is mounted on the shaft slip-out preventing groove portion 146.

Now, the shaft insertion hole 139 is formed to have an inner diameter slightly larger than the outer diameter of the shaft main body 133 for enabling the rotation of the rotation shaft 131 inserted in the shaft insertion hole 139 without any slidable contact with the inner peripheral surface of the shaft insertion hole 139. In this case, the shaft insertion hole 139 is formed to include a gap 142 of a space x2, which is sufficient for preventing a lubricating oil 143 filled between the inner peripheral surface of the shaft insertion hole 139 and the outer peripheral surface of the shaft main body in the housing from leaking from the inside of the housing 135.

A tapered portion 144 is formed on the outer peripheral surface, which is opposed to the inner peripheral surface of the shaft insertion hole 139, of the rotation shaft 131. The tapered portion 144 inclines to enlarge the gap 142, which is formed between the outer peripheral surface of the rotation shaft 131 and the inner peripheral surface of the shaft insertion hole 139, toward the outside of the housing 135. The tapered portion 144 forms a pressure gradient in the gap 142 formed between the outer peripheral surface of the rotation shaft 31 and the inner peripheral surface of the shaft insertion hole 139. Consequently, a force drawing the lubricating oil 143 filled in the housing 135 into the inside of the housing 135 is generated. Because the lubricating oil 143 is drawn into the inside of the housing 135 at the time of the rotation of the rotation shaft 131, the lubricating oil 143 surely permeates in the dynamic pressure generating grooves 141 of the radial bearing 134 composed of the dynamic pressure fluid bearing to generate a dynamic pressure. Then, the stable support of the rotation shaft 131 is realized, and besides, the leakage of the lubricating oil 143 filled in the housing 135 can be prevented.

In the bearing unit 130 configured as shown in FIG. 22, the rotation shaft 131 is exposed at only the one end on the side of the shaft insertion hole 139, and the whole part of the bearing unit 130 except the small gap in the shaft insertion hole 139 is covered by a housing member. Consequently, the leakage of the lubricating oil 143 to the outside of the housing 135 can be prevented. Moreover, because a communicating portion to the outside is also only the gap of the shaft insertion hole 139, the scattering of the lubricating oil due to an impact can be prevented. Furthermore, the bearing unit 130 can prevent the rotation shaft 131 from falling off from the housing 135 with the washer 145.

However, the bearing unit 130 described above is provided with the washer 145, or the shaft slip-out preventing member, on the side of the bottom sealing portion 137 being the side of the sealing portion of the housing 135. Owing to the configuration and the structure of the bottom sealing portion 137 of the housing main body 136 for providing the washer 145, it is difficult to reduce the length of the bearing unit 130 in the shaft direction.

Moreover, as a further bearing unit for rotatably supporting a rotation shaft, one configured as shown in FIG. 23 is known.

A bearing unit 160 shown in FIG. 23 rotatably supports a rotation shaft 161. The bearing unit 160 is provided with a radial bearing 164 supporting the rotation shaft 161 in its peripheral rotation direction, and a housing 165 accommodating the radial bearing 164.

In the bearing unit 160, the radial bearing 164 constitutes a dynamic pressure fluid bearing together with a lubricating oil being a viscous fluid filled in the housing 164, and dynamic pressure generating grooves 171 are formed on an inner peripheral surface, in which the rotation shaft 161 is inserted.

As shown in FIG. 23, the housing 165 accommodating the radial bearing 164 and a thrust bearing 170 therein is composed of a housing main body 166 shaped in a cylinder, a bottom sealing portion 167 formed integrally with the housing main body 166 to constitute one end side portion for sealing the one end side of the housing main body 166, and an upper sealing portion 168 provided on the opened other end side of the housing main body 166.

A shaft insertion hole 169, through which the rotation shaft 161 supported rotatably by the radial bearing 164 accommodated in the housing 165 is inserted, is formed in the central part of the upper sealing portion 168. The thrust bearing 170 for rotatably supporting a bearing supporting portion 162 formed at the one end in the thrust direction of the rotation shaft 161 supported by the radial bearing 164 is formed on an inner surface side of the bottom sealing portion 167 of the housing main body 166.

The thrust bearing 170 is formed as a pivot bearing supporting the bearing supporting portion 162 of the rotation shaft 161 at a point. The bearing supporting portion 162 is formed in a circular arc or a tapered tip.

After the radial bearing 164, the thrust bearing 170 and the rotation shaft 161 have been attached on the housing main body 166, the upper sealing portion 168 is welded. Thereby, the housing 165 configured as described above is integrally formed.

The rotation shaft 161 is supported by the housing 165 in a manner such that, the bearing supporting portion 162 on the one end side thereof is supported by the thrust bearing 170, the outer peripheral surface of the shaft main body 163 is supported by the radial bearing 164, and the side of an attachment portion 180 provided on the other end side protrudes from the shaft insertion hole 169 formed in the upper sealing portion 168 of the housing 165.

Moreover, on the rotation shaft 161, a protruding piece 177 as a shaft slip-out preventing mechanism is formed on the one end side of the bottom sealing portion 167 between the shaft main body 163 and the bearing supporting portion 162 so as to form a large diameter portion to have a surface wider than that of the shaft main body 163. The protruding piece 177 is shaped in a disc, and has a protruding portion 178 to be engaged with the radial bearing 164 when the rotation shaft 161 moves upward. The protruding portion 178 of the protruding piece 177 prevents the rotation shaft 161 from slipping out of the housing 165.

Now, the shaft insertion hole 169 is formed to have an inner diameter slightly larger than the outer diameter of the shaft main body 163 for enabling the rotation of the rotation shaft 161 inserted into the shaft insertion hole 169 without any slidable contact with the inner peripheral surface of the shaft insertion hole 169. In this case, the shaft insertion hole 169 is formed to include a gap 172 of a space x3, which is sufficient for preventing a lubricating oil 163 filled between the inner peripheral surface of the shaft insertion hole 169 and the outer peripheral surface of the shaft main body from leaking from the inside of the housing 165.

A tapered portion 174 is formed on the outer peripheral surface, which is opposed to the inner peripheral surface of the shaft insertion hole 169, of the rotation shaft 161. The tapered portion 174 inclines to enlarge the gap 172, which is formed between the outer peripheral surface of the rotation shaft 161 and the inner peripheral surface of the shaft insertion hole 169, toward the outside of the housing 165. The tapered portion 174 forms a pressure gradient in the gap 172 formed between the outer peripheral surface of the rotation shaft 161 and the inner peripheral surface of the shaft insertion hole 169. Consequently, a force drawing a lubricating oil 173 filled in the housing 165 into the inside of the housing 165 is generated. Because the lubricating oil 173 is drawn into the inside of the housing 165 at the time of the rotation of the rotation shaft 161, the lubricating oil 173 surely permeates in the dynamic pressure generating grooves 171 of the radial bearing 164 composed of the dynamic pressure fluid bearing to generate a dynamic pressure. Then, the stable support of the rotation shaft 161 is realized, and besides, the leakage of the lubricating oil 173 filled in the housing 165 can be prevented.

In the bearing unit 160 configured as shown in FIG. 23, the rotation shaft 161 is exposed at only the one end on the side of the shaft insertion hole 169, and the whole part of the bearing unit 160 except the small gap in the shaft insertion hole 169 is covered by a housing member. Consequently, the leakage of the lubricating oil 173 to the outside of the housing 165 can be prevented. Moreover, because a communicating portion to the outside is also only the gap of the shaft insertion hole 169, the scattering of the lubricating oil due to an impact can be prevented. Furthermore, the bearing unit 160 can prevent the rotation shaft 161 from falling off from the housing 165 with the protruding portion 178 of the protruding piece 177.

However, owing to the structure in which the protruding piece 177 is formed on the side of the bottom sealing portion 167, or the side of the sealing portion of the housing 165, for shaft slip-out preventing, the bearing unit 160 described above is difficult to reduce the length thereof in the shaft direction.

Consequently, in these bearing units 100, 130 and 160, general versatility and selectivity are limited owing to the length of the bearing unit in the shaft direction, and the degree of freedom of the design of an article using these bearing units is also limited.
[Patent Document 1] Japanese Patent Application Publication (KOKAI) 2003-130043

### SUMMARY OF THE INVENTION

It is an object of the present invention to provide a bearing unit having a reduced length in the shaft direction while having the shaft slipping-off preventing function for heightening the general versatility thereof, the selectivity thereof and the degree of freedom of designing an article using the bearing unit to enable the size of the article to be reduced, and a motor and electronic equipment, both including the bearing unit.

For achieving the object, a bearing unit according to the present invention includes a shaft; a radial bearing for supporting a peripheral rotation direction of the shaft; a thrust bearing for supporting one end of the shaft in a thrust direction; a housing having the radial bearing and the thrust bearing, both arranged therein, and being formed in a structure sealed except for a shaft insertion hole, through which the shaft is inserted, and a viscous fluid to be filled in the housing, wherein a locking portion for preventing shaft slip-out is provided on an inner surface side of the housing, which is a peripheral portion of the shaft insertion hole, in a state of abutting a part of the shaft.

As described above, in the bearing unit according to the present invention, as a slip-out preventing mechanism for preventing the slip-out of the shaft, the locking portion for locking the shaft by abutting against the shaft is formed in the peripheral portion of the shaft insertion hole on the inner surface side of the housing. Consequently, the slip-out of the shaft from the radial bearing is prevented by the locking portion formed on the shaft-opened side. In the bearing unit, by forming the locking portion, there is no necessity for forming any slip-out preventing mechanisms such as a slip-out preventing member and a protruding piece formed to have a diameter larger than that of the portion supported by a radial bearing, which have been necessary on the housing sealing portion side of a conventional bearing unit considering the prevention of shaft slip-out, and it becomes possible to achieve the prevention of the shaft slip-out.

Consequently, in the bearing unit, by the locking portion formed in the peripheral portion of the shaft insertion hole of the housing, the length of the bearing unit in the shaft direction can be reduced. Moreover, in the bearing unit, by reducing the length in the shaft direction, the general versatility and the selectivity of the bearing unit can be improved, and the degree of freedom of the design of a product using the bearing unit can be improved to enable to make the size of the product smaller.

A motor according to the present invention to be proposed for achieving the above-mentioned object is one including a bearing unit for supporting a rotor rotatably to a stator, and the one using the above-mentioned bearing unit as the bearing unit for the motor.

Moreover, electronic equipment according to the present invention to be proposed for achieving the above-mentioned object is one including a motor having a bearing unit for supporting a rotor rotatably to a stator, and the one using the above-mentioned bearing unit as the bearing unit.

According to the present invention, a locking portion for achieving the prevention of shaft slip-out by abutting against a part of the shaft to lock the shaft is formed in a peripheral portion of the shaft insertion hole of the housing. Consequently, while the invention holds the shaft slip-out preventing function, the invention can omit the slip-out preventing member on the housing sealing portion side, which has conventionally been provided. Consequently, parts such as a slip-out preventing member on the housing sealing portion side, which have been conventionally necessary, can be deleted to reduce the cost. Moreover, the length of the bearing unit itself in the shaft direction thereof can be reduced. Consequently, the general versatility and the selectivity of the bearing unit can be improved, and the degree of freedom of the design of an article using the bearing unit is improved. Moreover, while the rotation property thereof is kept, the size thereof can be reduced.

### BRIEF DESCRIPTION OF THE DRAWINGS

FIG. 1 is a perspective view showing an information processing apparatus (electronic equipment) to which the present invention is applied;

FIG. 2 is a sectional view showing a cross section taken along a line II-II in FIG. 1;

FIG. 3 is a perspective view showing a heat radiator using a motor to which the present invention is applied;

FIG. 4 is a sectional view showing a structure of the motor to which the present invention is applied;

FIG. 5 is a sectional view showing a bearing unit to which the present invention is applied;

FIG. 6 is a perspective view showing dynamic pressure generating grooves formed on an inner peripheral surface of a radial bearing;

FIG. 7 is a sectional view showing a gap formed by an outer peripheral surface of a rotation shaft and an inner peripheral surface of a shaft insertion hole provided in a housing;

FIG. 8 is a view for explaining a step of assembling the bearing unit to which the present invention is applied;

FIG. 9 is a view for explaining integrating a bottom sealing portion with a main body of the housing in the assembling step of the bearing unit to which the present invention is applied;

FIG. 10 is a view showing a state where assembling is completed in the assembling step of the bearing unit to which the present invention is applied;

FIG. 11 is a cross-sectional view showing another bearing unit to which the present invention is applied;

FIG. 12 is a view for explaining a step of assembling another bearing unit to which the present invention is applied;

FIG. 13 is a view for explaining integrating a bottom sealing portion with a main body of the housing in the assembling step of another bearing unit to which the present invention is applied;

FIG. 14 is a cross-sectional view showing still another bearing unit to which the present invention is applied;

FIG. 15 is a view for explaining a step of assembling still another bearing unit to which the present invention is applied;

FIG. 16 is a view for explaining integrating an upper sealing portion with a housing main body in the assembling step of another bearing unit to which the present invention is applied;

FIG. 17 is a cross-sectional view showing an example in which a thrust bearing comprises a dynamic pressure bearing;

FIG. 18 is a perspective view showing dynamic pressure generating grooves formed on an inner peripheral surface of a radial bearing in a bearing unit in which the thrust bearing comprises the dynamic pressure bearing;

FIG. 19 is a plan view showing dynamic pressure generating grooves formed on an inner peripheral surface on the side of a bottom sealing portion of the bearing unit in which the thrust bearing comprises the dynamic pressure bearing;

FIG. 20 is a plan view showing dynamic pressure generating grooves formed on an inner peripheral surface on the side of an upper sealing portion of the bearing unit in which the thrust bearing comprises the dynamic pressure bearing;

FIG. 21 is a cross-sectional view showing a bearing unit which has been conventionally used;

FIG. 22 is a cross-sectional view showing another bearing unit which has been conventionally used; and

FIG. 23 is a cross-sectional view showing still another bearing unit which has been conventionally used.

### DESCRIPTION OF PREFERRED EMBODIMENTS

In the following, referring to the attached drawings, an information processing apparatus to which the present invention is applied is described.

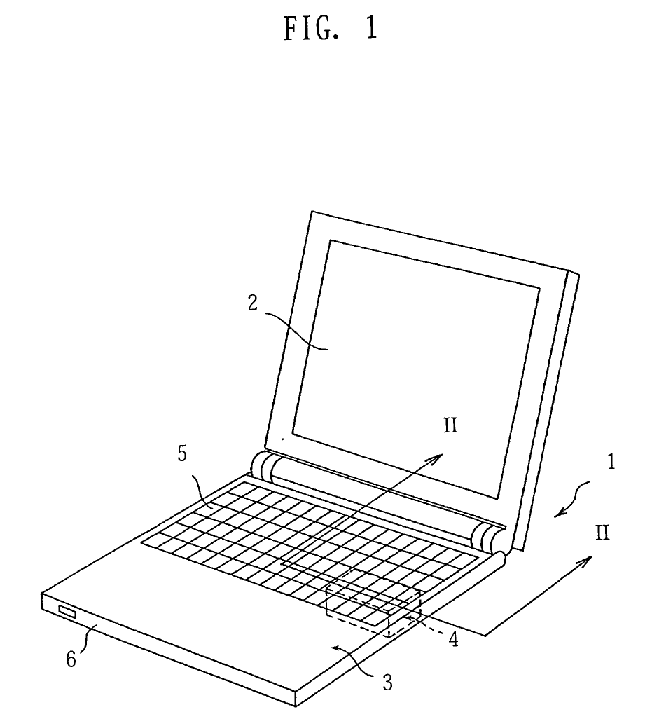

As shown in FIG. 1, the information processing apparatus to which the present invention is applied is a notebook-type personal computer including a display unit 2 for displaying a result of information processing and the like, and a computer main body 3 having built therein an information processing unit for performing the arithmetic processing of various pieces of information. A keyboard 5 for inputting an operating instruction of a computer 1 or for inputting various pieces of information is provided on the upper surface side of the computer main body 3, and a heat radiator 4 is provided in the inside of the main body 3. The heat radiator 4 radiates the heat generated by an information processing circuit such as a CPU arranged in the inside of the computer main body 3, or by a disk unit and the like to the outside of the computer main body 3 to function also as a cooling device for cooling the inside of the computer main body 3.

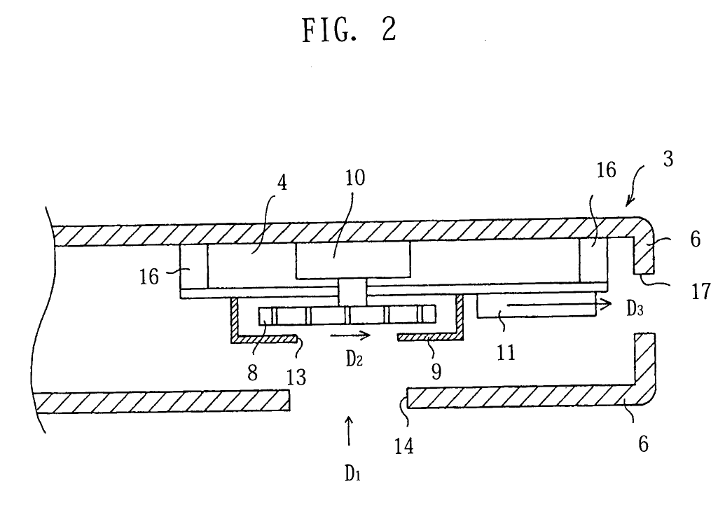

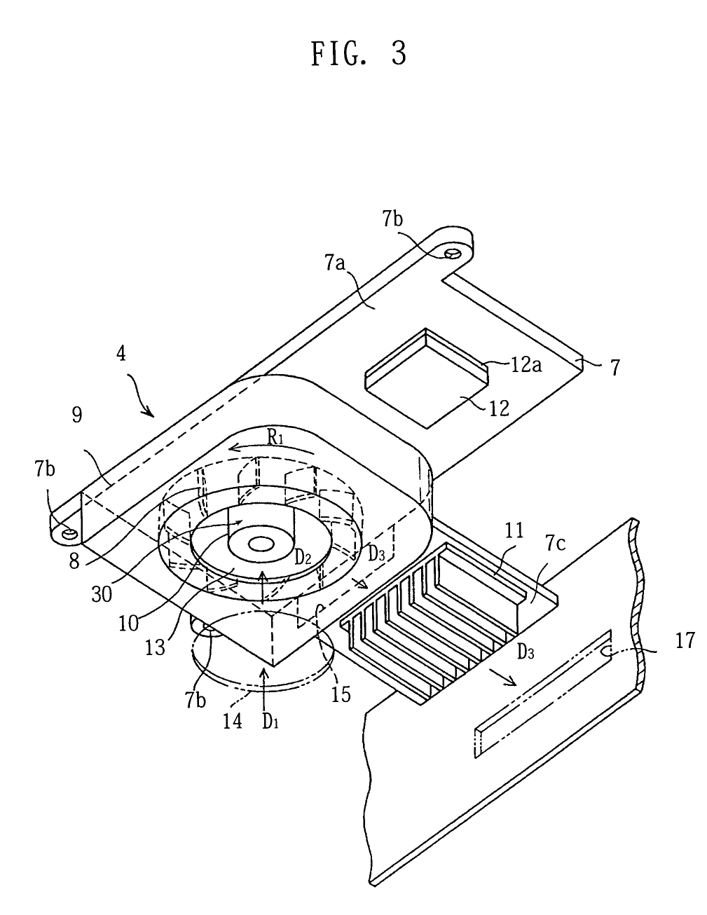

As shown in FIG. 2, the heat radiator 4 built in the computer main body 3 is housed in a housing 6 constituting the computer main body 3. As shown in FIG. 3, the heat radiator 4 includes a metal base 7, a motor 10 attached to the base 7, a fan 8 operated by the motor 10 to rotate, a fan case 9 housing the fan 8 therein, and a heat sink 11.

As shown in FIG. 3, the base 7 is formed almost in a letter L. A heating element 12 such as a central processing unit (CPU), which generates heat at the time of being driven by being turned on to be conducted, is attached on one surface 7a on one end side of the base 7 formed almost in the letter L. The heating element 12 is attached on the side of the surface 7a of the base 7 on one side thereof with a heat transfer seal 12a put between them.

The motor 10 is attached almost at the central part on the side of the surface 7a of the base 7 on one side thereof, and also the fan case 9 accommodating therein the fan 8 operated by the motor 10 to rotate is attached on the surface 7a. A circular intake port 13 opening a position corresponding to the central part of the fan 8 rotated by the motor 10 is formed in the fan case 9. An opening 14 is formed to communicate with the intake port 13 at a position opposed to the intake port 13 formed in the fan case 9 on the side of the bottom surface of the housing 6. Moreover, an exhaust port 15 for exhausting the air absorbed through the intake port 13 to the outside is formed in the fan case 9.

The heat sink 11 is fixed on a surface 7c on one side on the other end side of the base 7. The heat sink 11 is a heat sink in a corrugated shape or a shape of fins, and is made of a metal having a property superior in heat radiation such as aluminum. It is desirable to manufacture the base 7 and the fan case 9 also from aluminum or iron being metals superior in heat radiation.

A plurality of mounting holes 7b, through which screws used for attaching the base 7 into the housing 6 are inserted, is formed in the base 7, to which the heating element 12 is attached and the heat radiator 4 and the heat sink 11 for radiating the heat generated from the heating element 12 are attached. The base 7 is attached in the inside of the housing 6 by fixing the fixing screws inserted into the mounting holes 7b to bosses 16 provided in the inside of the housing 6, as shown in FIG. 2.

As shown in FIGS. 2 and 3, the heat sink 11 is arranged at a position opposed to a penetration hole 17 formed on a side face of the housing 6 when the base 7 is attached in the housing 6.

When the motor 10 is driven and the fan 8 is rotated in the direction of an arrow R₁ in FIG. 3 by the motor 10, the heat radiator 4 configured as described above absorbs the air on the outside of the apparatus into the direction of an arrow D₁ in FIGS. 2 and 3 though the opening 14 formed in the housing 6, and further the radiator 4 sucks the air in the inside of the fan case 9 through the intake port 13. The air sucked into the fan case 9 by the rotation of the fan 8 circulates into the direction of an arrow D₂ in FIGS. 2 and 3, and furthermore the air circulates into the direction of an arrow D₃ in FIG. 3 to flow in the heat sink 11. Then, the air is exhausted to the outside of the housing 6 through the penetration hole 17.

Now, the heat generated by the driving of the heating element 12 is transferred to the heat sink 11 through the base 7 formed of a metal superior in heat radiation. At this time, by the circulation of the air introduced from the outside of the housing 6 in the plurality of fins of the heat sink 11 by the rotation of the fan 8 of the heat radiator 4 with the motor 10, the air absorbs the heat transferred to the heat sink 11, and radiates the heat to the outside of the housing 6 through the penetration hole 17.

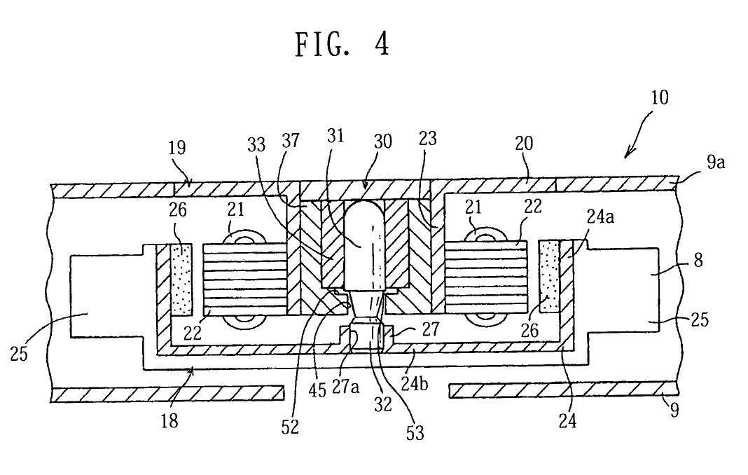

The motor 10, which the present invention is applied to and is used for the heat radiator, is provided with a rotor 18 and a stator 19, as shown in FIG. 4.

The stator 19 is integrally formed on the side of an upper surface plate 9a of the fan case 9, which accommodates the fan 8 rotated by the motor 10 therein together with the motor 10. The stator 19 is equipped with a stator yoke 20, a bearing unit 30 to which the present invention is applied, a coil 21 and a core 22, around which the coil 21 is wound. The stator yoke 20 may be one formed integrally with the upper surface plate 9a of the fan case 9, namely one made of a part of the fan case 9, or may be one formed independently of the fan case 9. The stator yoke 20 is formed of iron, for example. The bearing unit 30 is fixed in a holder 23 formed at the central part of the stator yoke 20 in a shape of a cylinder by press fitting, by adhesion, or further by both of the press fitting and the adhesion.

It is noted that the holder 23, into which the bearing unit 30 is inserted by the press fitting, is formed integrally with the stator yoke 20 in a cylindrical shape.

As shown in FIG. 4, the core 22, around which the coil 21, to which a drive current is supplied, is wound, is attached on an outer peripheral portion of the holder 23 formed integrally with the stator yoke 20.

The rotor 18 constituting the motor 10 together with the stator 19 is attached to a rotation shaft 31 supported by the bearing unit 30 rotatably, and rotates integrally with the rotation shaft 31. The rotor 18 includes a rotor yoke 24 and the fan 8, which rotates integrally with the rotor yoke 24 and includes a plurality of fan blades 25. The fan blades 25 of the fan 8 are formed integrally with the rotor yoke 24 by the outsert molding to the outer peripheral surface of the rotor yoke 24.

A ring-shaped rotor magnet 26 is provided on the inner peripheral surface of a cylinder portion 24a of the rotor yoke 24 in a manner of being opposed to the coil 21 of the stator 19. The magnet 26 is a plastic magnet, in which S poles and N poles are alternately magnetized in its peripheral rotation direction. The magnet 26 is fixed on an inner peripheral surface of the rotor yoke 24 with an adhesive.

The rotor yoke 24 is rotatably attached integrally with the rotation shaft 31 by the press fitting of a boss portion 27, where a through-hole 27a formed at the central part of a flat plate portion 24b is provided, to an attachment portion 32 formed at the tip side of the rotation shaft 31 supported by the bearing unit 30.

In the motor 10 having the configuration described above, when a drive current is supplied from a drive circuit unit provided on the outside of the motor 10 to the coil 21 on the side of the stator 19 in a predetermined energization pattern, the rotor 18 rotates integrally with the rotation shaft 31 by an influence of a magnetic field generated in the coil 21 and-a magnetic field from the rotor magnet 26 on the side of the rotor 18. By the rotation of the rotor 18, the fan 8, which includes the plurality of the fan blades 25 and is attached to the rotor 18, also rotates integrally with the rotor 18. By the rotation of the fan 8, the air on the outside of the apparatus is sucked in the direction of the arrow D₁ in FIGS. 2 and 3 through the opening 14 formed in the housing 6, and circulates into the direction of the arrow D₂. While further circulating in the heat sink 11, the air is exhausted to the outside of the housing 6 through the penetration hole 17. Thereby, the heat generated by the heating element 12 is radiated to the outside of the computer main body 3, and then the inside of the computer main body 3 is cooled.

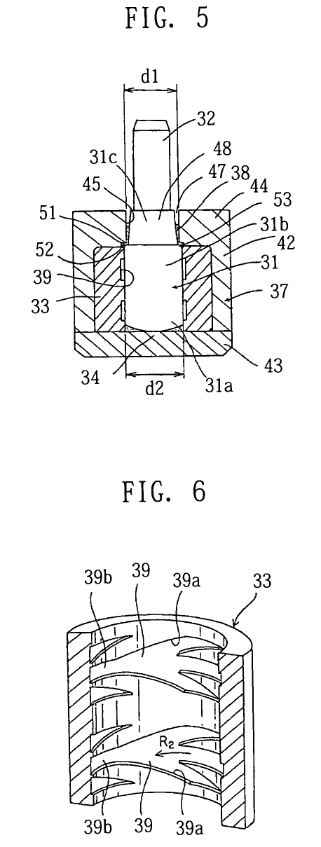

As shown in FIGS. 4 and 5, the bearing unit 30 supporting the rotation shaft 31 of the above-mentioned motor 10 rotatably is equipped with a radial bearing 33 supporting the rotation shaft 31 in its peripheral rotation direction, and a housing 37 having the radial bearing 33 accommodated therein.

The radial bearing 33 is formed in a cylinder shape with a sintered metal. The radial bearing 33 constitutes a fluid dynamic bearing together with a lubricating oil 38 being a viscous fluid filled in the housing 37, and dynamic pressure generating grooves 39 are formed on an inner peripheral surface of the radial bearing 33, in which the rotation shaft 31 is inserted.

As shown in FIG. 6, the dynamic pressure generating grooves 39 are severally configured by forming a pair of V-shaped grooves 39a on the inner peripheral surface of the radial bearing 33 to be continuous in a peripheral rotation direction with a connection groove 39b. The dynamic pressure generating grooves 39 are severally formed in order that the tip side of the pair of V-shaped grooves 39a may face toward a rotation direction R₂ of the rotation shaft 31. In the present embodiment, the pair of dynamic pressure generating grooves 39 are formed to be arranged at an upper position and a lower position in the shaft direction of the radial bearing 33 shaped in a cylinder in parallel with each other. The number and the sizes of the dynamic pressure generating grooves formed on the radial bearing 33 are suitably selected according to the size, the length and the like of the radial bearing 33. Incidentally, the radial bearing 33 may be made of brass, stainless or a polymer material.

When the rotation shaft 31 inserted in the radial bearing 33 continuously rotates in the direction of the arrow R₂ (rotation direction) in FIG. 6 around a central axis CL (not shown), the lubricating oil 38 filled in the housing 37 circulates in the dynamic pressure generating grooves 39, and the radial bearing 33 formed as the fluid dynamic bearing generates a dynamic pressure between the outer peripheral surface of the rotation shaft 31 and the inner peripheral surface of the radial bearing 33 to support the rotation shaft 31. The dynamic pressure generated at this time extremely reduces a friction coefficient between the rotation shaft 31 and the radial bearing 33 to realize the smooth rotation of the rotation shaft 31.

As shown in FIG. 5, the housing 37 accommodating the radial bearing 33 supporting the rotation shaft 31 is shaped to accommodate the radial bearing 33, which is formed in the shape of a cylinder, to enclose the radial bearing 33 therein. The housing 37 is composed of a housing main body 42, on which an upper sealing portion 44 is integrally formed, and a bottom sealing portion 43 for sealing a lower part opened portion formed on the side opposed to the upper sealing portion 44 of the housing main body 42. The housing main body 42 has a shape in a cylinder, and the upper sealing portion 44 is integrally formed on one end side of the housing main body 42. The housing main body 42 and the upper sealing portion 44 are made of a resin. A shaft insertion hole 45, through which the rotation shaft 31 rotatably supported by the radial bearing 33 accommodated in the housing 37 is inserted, is formed in the central part of the upper sealing portion 44.

A thrust bearing 34 for rotatably supporting a bearing supporting portion 31a formed at one end in the thrust direction of the rotation shaft 31 supported by the radial bearing 33 is integrally formed in the central part of the bottom sealing portion 43 on the inner surface side thereof. The bottom sealing portion 43 is made of a resin to be used as the thrust bearing 34 commonly. The thrust bearing 34 is formed as a pivot bearing supporting the bearing supporting portion 31a of the rotation shaft 31 at a point. The bearing supporting portion 31a is formed in a shape of a circular arc or a tapered shape.

A shaft slip-out preventing mechanism for preventing the rotation shaft 31 from slipping out of the radial bearing 33 and the housing 37 is provided in the peripheral portion of the shaft insertion hole 45 on the inner surface side of the housing 37 in the upper sealing portion 44 of the housing 37. As the shaft slip-out preventing mechanism, a stepwise recessed portion 51 having a step portion to be a locking portion 52 formed in a step is formed on the inner surface side of the shaft insertion hole 45 in the upper sealing portion 44. That is to say, the stepwise recessed portion 51 is made by forming a recess in a cylinder in the peripheral portion of the shaft insertion hole 45, and includes a step portion of a step to be the locking portion 52 from the inner surface of the upper sealing portion toward the outside of the housing.

The locking portion 52 of the stepwise recessed portion 51 locks an abutting portion 53, which is a part of the rotation shaft 31 and will be described later, when the rotation shaft 31 is pulled up from the inside of the housing to prevent the rotation shaft 31 from jumping out of the housing 37, namely the falling off of the rotation shaft 31. The step portion to be the locking portion 52 is formed in an annular shape. The outer diameter of the step portion is an inner diameter d3 of the stepwise recessed portion 51, and the inner diameter of the step portion is an inner diameter d1 of the shaft insertion hole 45.

The housing 37 configured as described above is integrally formed by welding the housing main body 42 accommodating the radial bearing 33 shaped in a cylinder to the bottom sealing portion 43. The housing 37 is structured to seal the inside thereof tight except for the shaft insertion hole 45.

The synthetic resin material configuring the housing 37 is not especially limited, but it is desirable to use a material increasing a contact angle to the lubricating oil 38, which indicates repelling to the lubricating oil 38 to be filled in the housing 37. Moreover, it is preferable to use a synthetic resin material having superior lubricity as the housing 37. For example, the housing 37 is made of polyoxymethylene (POM), but may be formed using a fluorine-series synthetic resin such as polyimide, polyamide and polyacetal, and a synthetic resin such as polytetrafluoroethylene (Teflon (registered trademark)) and nylon. Moreover, a synthetic resin such as polycarbonate (PC) and acrylonitrile butadiene styrene (ABS) may be used. Furthermore, the housing 37 may be made of a liquid crystal polymer, by which extremely accurate molding can be performed. In particular, in a case where the liquid crystal polymer is used as the housing 37, the housing 37 holds a lubricating oil, and has a superior abrasion resistance.

The rotation shaft 31 rotatably supported by the radial bearing 33 arranged in the housing 37 and the thrust bearing 34 integrally formed with the housing 37 is composed of a shaft main body 31b supported by the radial bearing 33, the bearing supporting portion 31a, which is formed in a circular arc or a tapered tip continuously to the shaft main body 31b and is supported by the thrust bearing 34, and an attachment portion 32 on the other end side of which, for example, a rotor 18 of a motor 10 being a body of rotation is attached.

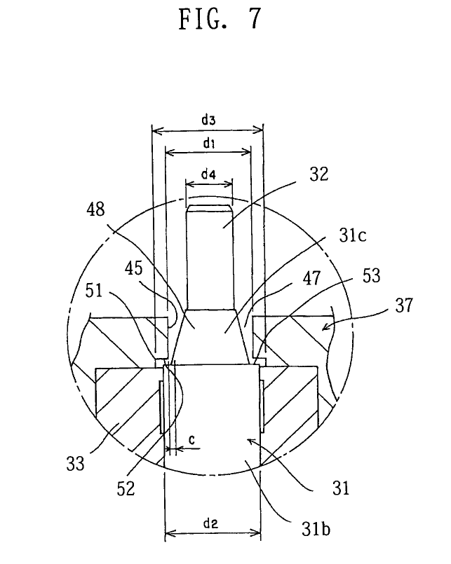

Moreover, as shown in FIGS. 5 and 7, a tapered insertion portion 31c, which includes a stepped portion from the shaft main body 31b to be the abutting portion 53 for shaft slip-out preventing and is opposed to the inner surface of the shaft insertion hole 45, is formed on the rotation shaft 31. Hereupon, an outer diameter d4 of the attachment portion 32 is formed to be slightly smaller than an outer diameter d2 of the shaft main body 31b. The reason is that the locking portion 52 formed in the upper sealing portion 44 of the housing 37 functions for preventing the rotation shaft 31 from slipping-out. That is to say, the inner diameter d1 of the shaft insertion hole 45 is formed to be smaller than the outer diameter d2 of the shaft main body 31b in order that the shaft main body 31b does not slip out of the shaft insertion hole 45 after being inserted therein. Hereupon, the outer diameter d2 of the shaft main body 31b is the same as the outer diameter of the abutting portion 53. Then, because the inner diameter d4 of the attachment portion 32 is smaller than the inner diameter d1 of the shaft insertion hole 45 in order that the attachment portion 32 may be inserted into the shaft insertion hole 45 at the time of assembly, the outer diameter d4 is formed to be smaller than the outer diameter d2 of the shaft main body 31b.

The rotation shaft 31 is supported by the housing 37 in a manner, as shown in FIG. 5, such that the bearing supporting portion 31a at one end side is supported by the thrust bearing 34, the outer peripheral surface of the shaft main body 31b is supported by the radial bearing 33, and the side of the attachment portion 32 formed on the other end side protrudes from the shaft insertion hole 45 formed in the upper sealing portion 44 of the housing main body 42.

The inner diameter d1 of the shaft insertion hole 45 formed in the upper sealing portion 44 is formed to be smaller than the outer diameter d2 of the shaft main body 31b supported by the radial bearing 33. Moreover, the inner diameter d3 of the stepwise recessed portion 51 formed in the shaft insertion hole 45 is formed to be larger than the outer diameter d2 of the shaft main body 31b. Hereupon, the inner diameter d3 of the stepwise recessed portion 51 means the inner diameter of a cylinder-shaped recess formed in the upper sealing portion 44.

Consequently, when the shaft main body 31b is pulled up from the housing 37, the abutting portion 53 formed on the shaft-opened side of the shaft main body 31b abuts against the locking portion 52 formed in the stepwise recessed portion 51 of the housing to be locked by the locking portion 52. Thereby, the movement of the rotation shaft 31 into the shaft direction is regulated, and the pulling up of the rotation shaft 31 further than the position is prevented.

Incidentally, in the bearing unit 30, the shaft slip-out preventing function is implemented by the stepwise abutting portion 53 is formed above the shaft main body 31b of the rotation shaft 31, and by making the abutting portion 53 abut against the locking portion 52 of the housing 37, but the shape of the rotation shaft is not limited to the above one. For example, the rotation shaft may be configured to have a conical taper as an abutting portion. That is to say, the rotation shaft may be configured to have the shaft slip-out preventing function by making the locking portion of the housing abut against the tapered portion of the rotation shaft. Moreover, the shape of the housing is not limited to the above-mentioned one. For example, the stepwise recessed portion 51 is not always necessary for the housing 37. That is to say, the housing may be configured to have the shaft slip-out preventing function by forming the outer diameter of the rotation shaft to be larger than the inner diameter of the shaft insertion hole of the housing to make the abutting portion of the rotation shaft abut against the peripheral portion of the shaft insertion hole of the housing.

Consequently, even in a case where the rotation shaft 31 is lifted up at the assembly thereof, or even in a case where the rotation shaft 31 is lifted upward owing to an impact or the like, the locking portion 52 of the housing 37 abuts against the abutting portion 53 of the shaft main body 31b. Consequently, the bearing unit 30 prevents the rotation shaft 31 from slipping out of the housing 37.

Now, the shaft insertion hole 45 of the housing 37 is formed to have an inner diameter slightly larger than the outer diameter of an inserted portion 31c of the rotation shaft 31 for enabling the rotation of the inserted portion 31c being a portion of the rotation shaft 31 inserted in the shaft insertion hole 45 without any slidable contact with the inner peripheral surface of the shaft insertion hole 45. In this case, the shaft insertion hole 45 is formed to include a gap 47 of a space c, which is sufficient for preventing the lubricating oil 38 filled between the inner peripheral surface of the insertion hole 45 and the outer peripheral surface of the inserted portion 31c in the housing 37 from leaking from the inside of the housing 37. The upper sealing portion 44, in which the shaft insertion hole 45 is formed to form the gap 47 preventing the leakage of the lubricating oil 38 filled between the shaft insertion hole 45 and the rotation shaft 31 in the housing 37, configures an oil seal portion.

Because the upper sealing portion 44, which is integrally formed with the housing 37, is made of a synthetic resin such as polyimide, polyamide or nylon, the contact angle of the inner peripheral surface of the shaft insertion hole 45 to the lubricating oil 38 can be secure to be about 60 degrees. The bearing unit 30, to which the present invention is applied, includes the inner peripheral surface of the shaft insertion hole 45 constituting the oil seal portion, and can increase the contact angle of the lubricating oil 38 to the upper sealing portion 44 without coating any surface-active agents on the upper sealing portion 44. Consequently, it can be prevented that the lubricating oil 38 moves to the outside of the housing 37 through the shaft insertion hole 45 by the centrifugal force generated by the rotation of the rotation shaft 31.

Moreover, a tapered portion 48 is formed on an outer peripheral surface, which is opposed to the inner peripheral surface of the shaft insertion hole 45, of the rotation shaft 31. The tapered portion 48 inclines to enlarge the gap 47, which is formed between the outer peripheral surface of the rotation shaft 31 and the inner peripheral surface of the shaft insertion hole 45, toward the outside of the housing 37. The tapered portion 48 forms a pressure gradient in the gap 47 formed by the outer peripheral surface of the rotation shaft 31 and the inner peripheral surface of the shaft insertion hole 45. Consequently, a force drawing the lubricating oil 38 filled in the housing 37 into the inside of the housing 37 is generated. Because the lubricating oil 38 is drawn into the inside of the housing 37 at the time of the rotation of the rotation shaft 31, the lubricating oil 38 surely permeates in the dynamic pressure generating grooves 39 of the radial bearing 33 composed of the fluid dynamic bearing to generate a dynamic pressure. Then, the stable support of the rotation shaft 31 is realized, and beside, the leakage of the lubricating oil 38 filled in the housing 37 can be prevented.

In the bearing unit 30, to which the present invention is applied, the lubricating oil 38, which permeates the dynamic pressure generating groove 39 provided in the radial bearing 33 constituting the fluid dynamic bearing and generates a dynamic pressure, is filled to face to the gap 47 from the inside of the housing 37, which gap 47 is formed by the tapered portion 48 formed on the rotation shaft 31 and the inner peripheral surface of the shaft insertion hole 45, as shown in FIGS. 5 and 7. That is to say, the lubricating oil 38 is filled in the gap in the housing 37, and is further impregnated by the radial bearing 33 made of a sintered metal.

Now, the gap 47, which is formed between the tapered portion 48 formed on the rotation shaft 31 and the inner peripheral surface of the shaft insertion hole 45, is described. The minimum space of the gap 47 corresponds to the space c formed between the outer peripheral surface of the rotation shaft 31 and the inner peripheral surface of the shaft insertion hole 45. It is preferable that the space c is of from 20 μm to 200 μm, and it is most preferable to be about 100 μm. If the space c is smaller than 20 μm, it is difficult to ensure the molding accuracy of the housing 37 of the bearing unit 30 at the time of manufacturing the housing 37 with a synthetic resin by the integral molding. If the space c of the gap 47 is larger than 200 μm, the impact resistance property of the bearing unit 30 decreased. The impact resistance property indicates a property of preventing the scattering of the lubricating oil 38 filled in the housing 37 to the outside of the housing 37 when an impact is applied to the bearing unit 30.

An impact resistance property indicating the property of preventing the scattering of the lubricating oil 38 filled in the housing 37 to the outside of the housing 37 by is inversely proportional to the square of the space c of the gap 47. Moreover, an oil surface rising quantity caused by thermal expansion is inversely proportional to the magnitude of the space c, the impact resistance property is improved by narrowing the space c. However, the rise of the oil surface height of the lubricating oil 38 caused by a rise of the temperature becomes steep, and consequently the thickness of the shaft insertion hole 45 in the shaft direction becomes necessary to be thick.

For example, when the space c of the gap 47 formed between the rotation shaft 31 and the shaft insertion hole 45 is about 100 μm, and when the height H₁ of the shaft insertion hole 45, i.e. the thickness of the upper sealing portion 44 of the housing 37 is about 1 mm, in the bearing unit 30 including the rotation shaft 31 having a shaft diameter of from 2 mm to 3 mm, the impact resistance property of the bearing unit 30 is 1000 G or more, and the temperature resistance performance of the bearing unit 30 is 80° C. Consequently, it is possible to configure the highly reliable bearing unit 30 preventing the scattering of the lubricating oil 38 filled in the housing 37.

Moreover, because the tapered portion 48 inclining in order to enlarge the space c of the gap 47 formed between the outer peripheral surface of the rotation shaft 31 and the inner peripheral surface of the shaft insertion hole 45 to the outward of the housing 37 is provided in the bearing unit 30, to which the present invention is applied, a pressure gradient is formed in the space c of the gap 47 formed between the outer peripheral surface of the rotation shaft 31 and the inner peripheral surface of the shaft insertion hole 45, and a force drawing the lubricating oil 38 filled in the housing 37 into the inside of the housing 37 is generated by the centrifugal force generated at the time of the rotation of the rotation shaft 31.

That is to say, in the bearing unit 30, to which the present invention is applied, the gap 47 formed between the outer peripheral surface of the rotation shaft 31 and the inner peripheral surface of the shaft insertion hole 45 prevents the scattering of the lubricating oil 38 by a surface tension seal.

Now, the surface tension seal is described. The surface tension seal is a seal method utilizing the capillary phenomenon of a fluid. It is known that a drawing pressure generally becomes larger as a capillary tube becomes thinner from a formula indicating the rising height of a liquid by a capillary tube and relational expressions between pressures and heights of a fluid. Now, in the bearing unit 30, to which the present invention is applied, a lubricating oil 38 having permeated into a gap 47 formed between the outer peripheral surface of the rotation shaft 31 and the inner peripheral surface of the shaft insertion hole 45 is formed to be a circular ring. The drawing pressure in this case similarly becomes larger as a space c of the gap 47 formed between the outer peripheral surface of the rotation shaft 31 and the inner peripheral surface of the shaft insertion hole 45 becomes narrower. Incidentally, as a concrete calculation example, supposing that the space c of the gap 47 formed between the outer peripheral surface of the rotation shaft 31 and the inner peripheral surface of the shaft insertion hole 45 is 0.02 cm (0.2 mm), and that the surface tension γ of the viscous fluid is 30 dyn/cm², and that the contact angle θ of the lubricating oil 38 is 15°, then the drawing pressure is 2.86×10⁻³ atmospheres (atm). Because the drawing pressure becomes larger as the space c of the gap 47 becomes narrower, the formation of the tapered portion 48 on the rotation shaft 31 enables the lubricating oil 38 as the viscous fluid to be drawn into the narrower direction of the space c of the gap 47, i.e. the inside direction of the housing 37.

By thus forming the tapered portion 48, by which the space c of the gap 47, which is formed between the outer peripheral surface of the rotation shaft 31 and the inner peripheral surface of the shaft insertion hole 45 and constitutes the seal portion for preventing the leakage of the lubricating oil 38 filled in the housing 37 to the outside of the housing 37, becomes smaller toward the inside of the housing 37, the pressure gradient is produced in the lubricating oil 38 positioned in the gap 47 formed between the outer peripheral surface of the rotation shaft 31 and the inner peripheral surface of the shaft insertion hole 45. That is to say, the pressure gradient given to the lubricating oil 38 increases toward the inside of the housing 37, where the space c of the gap 47 becomes smaller. By the generation of the pressure gradient in the lubricating oil 38, the pressure P drawing in the lubricating oil 38 toward the inside of the housing 37 always operates on the lubricating oil 38. Consequently, even in a case where the rotation shaft 31 rotates, air is not involved into the lubricating oil 38 existing in the gap 47.

In a case where the tapered portion 48 described above is not formed, namely in a case where the space c of the gap 47 formed between the outer peripheral surface of the rotation shaft 31 and the inner peripheral surface of the shaft insertion hole 45 is constant in the height direction of the shaft insertion hole 45, no pressure gradient is generated in the lubricating oil 38 permeated in the gap 47 between the outer peripheral surface of the rotation shaft 31 and the inner peripheral surface of the shaft insertion hole 45. Consequently, the lubricating oil 38 uniformly exists in the gap 47. That is to say, by narrowing the space c between the outer peripheral surface of the rotation shaft 31 and the inner peripheral surface of the shaft insertion hole 45, the lubricating oil 38, which is permeated in the gap 47 and functions as the seal portion, sometimes moves in the gap 47 at the time of the rotation of the rotation shaft 31 to involve air E. If the air E is involved in the lubricating oil 38 as mentioned above, the air expands owing to a temperature change, an atmospheric pressure change and the like, and the expanded air scatters the lubricating oil 38 from the gap 47 constituting the seal portion to the outside of the housing 37.

On the contrary, by the formation of the tapered portion 48, at which the space c of the gap 47 formed between the outer peripheral surface of the rotation shaft 31 and the inner peripheral surface of the shaft insertion hole 45 becomes smaller toward the inside of the housing 37 like the bearing unit 30 to which the present invention is applied, the pressure gradient which makes the pressure larger toward the inside of the housing 37 is generated in the lubricating oil 38 permeated in the gap 47. Consequently, it can be prevented that the air is involved in the lubricating oil 38 when the rotation shaft 31 rotates.

Moreover, the formation of the tapered portion 48 as described above can not only prevent the scattering of the lubricating oil 38 permeated in the gap 47 formed between the outer peripheral surface of the rotation shaft 31 and the inner peripheral surface of the shaft insertion hole 45 to the outward of the housing 37 at the time when the rotation shaft 31 is eccentric to the shaft insertion hole 45 formed in the housing 37, but also can permeate the lubricating oil 38 over the whole circumference of the rotation shaft 31, and can prevent the exhaustion of the lubricating oil 38 in the circumference of the rotation shaft 31 to ensure the stable rotation of the rotation shaft 31.

When the rotation shaft 31 is inclined with regard to the shaft insertion hole 45 provided in the housing 37, in a case where the tapered portion 48 mentioned above is not formed, the lubricating oil 38 concentrates to the narrower part of the space c between the outer peripheral surface of the rotation shaft 31 and the inner peripheral surface of the shaft insertion hole 45, and the lubricating oil 38 is cut to involve the air at the wider portion of the space c on the opposite side. When the air is involved in the lubricating oil 38, the air expands owing to a temperature change, an atmospheric change or the like, and the lubricating oil 38 is scattered from the gap 47 constituting the seal portion to the outside of the housing 37.

On the contrary, by forming the tapered portion 48 on the rotation shaft 31 like the bearing unit 30, to which the present invention is applied, even when the rotation shaft 31 is inclined with regard to the shaft insertion hole 45 formed in the housing 37, the gap 47 of the same space c always exists on an elliptical orbit along which the inclined rotation shaft 31 rotates and the space c of the gap 47 formed on the outer peripheral surface of the rotation shaft 31 and the inner peripheral surface of the shaft insertion hole 45 on the elliptical orbit is constant over the whole circumference of the rotation shaft 31. Consequently, the phenomenon in which the lubricating oil 38 concentrates to the narrower side of the space c does not occur, and then it becomes possible to prevent the discharge of the lubricating oil 38 from the gap 47, and eventually to prevent the discharge of the lubricating oil 38 from the housing 37. Although the tapered portion 48 is formed on the side of the rotation shaft 31 in the above-mentioned bearing unit 30, the tapered portion 48 may be formed on the inner peripheral surface of the shaft insertion hole 45 on the side of the housing 37.

A process for manufacturing the bearing unit 30, which is configured as described above and the present invention is applied to, is described.

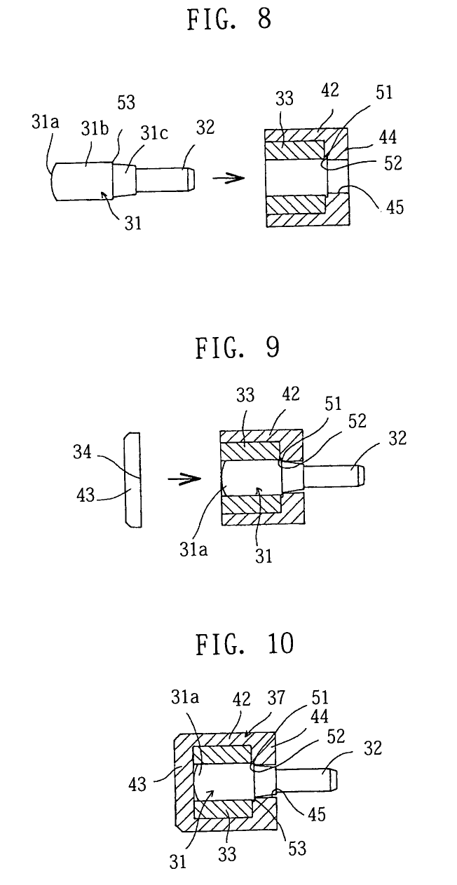

For manufacturing the bearing unit 30, to which the present invention is applied, as shown in FIG. 8, the rotation shaft 31 is inserted into the housing main body 42 accommodating the radial bearing 33 therein. At this time, the rotation shaft 31 is inserted from the opened portion side of the housing main body 42 in order that the side of the attachment portion 32 may be first inserted. Because the inner diameter of the attachment portion 32 of the rotation shaft 31 is formed to be smaller than the inner diameter of the shaft insertion hole 45, the attachment portion 32 is inserted from the shaft insertion hole 45 to protrude to the outside of the housing 37. Then, because the outer diameter d2 of the shaft main body 31b of the rotation shaft 31 is formed to be larger than the inner diameter d1 of the shaft insertion hole 45, the shaft main body 31b does not protrude from the shaft insertion hole 45. Moreover, because the outer diameter d2 of the shaft main body 31b is formed to be smaller than the inner diameter d3 of the stepwise recessed portion 51, the abutting portion 53 formed on the shaft main body 31b abuts against the locking portion 52 of the stepwise recessed portion 51.

Next, as shown in FIG. 9, the bottom sealing portion 43, on which the thrust bearing 34 is integrally formed, is welded to the opened portion of the housing main body 42 having accommodated the rotation shaft 31 and the radial bearing 33 to be integrated therewith.

It is noted that the integration of the housing main body 42 and the upper sealing member 44 may be performed by a technique such as heat sealing or ultrasonic sealing.

Then, as shown in FIG. 10, when the housing main body 42 accommodating the rotation shaft 31 and the radial bearing 33 and the bottom sealing portion 43 are integrated by being welded, the lubricating oil 38 is filled into the housing 37. The filling of the lubricating oil 38 is performed as follows. That is, the housing 37, in which the rotation shaft 31 is inserted, is thrown into a not shown filling bath containing a lubricating oil therein. Next, the filling bath, in which the housing has been thrown in, is vacuum-sucked by a vacuum apparatus. After that, by taking out the filling bath, which has been vacuum-sucked, into the air, the lubricating oil 38 is filled into the housing 37.

At this time, the lubricating oil 38 is filled in order to prevent the lubricating oil 38 from leaking from the inside of the shaft insertion hole 45 to the outside of the housing 37 in a case where the lubricating oil 38 expands owing to a temperature change, or in order not to generate a shortage of the filling of the lubricating oil 38 into the gap 47 formed between the rotation shaft 31 and the shaft insertion hole 45 in a case where the lubricating oil 38 contracts owing to a temperature change. That is to say, changes of the oil surface height of the lubricating oil 38 owing to temperature changes are set to be within a range of the inside of the shaft insertion hole 45.

By filling the lubricating oil 38 into the housing 37 by means of the vacuum suction using the vacuum apparatus, the pressure inside the housing 37 is in a state of being lower than that outside the housing 37. As a result, it can be easily prevented that the lubricating oil 38 leaks from the housing 37.

Because, in the bearing unit 30, to which the present invention is applied, the radial bearing 33 is made of a sintered metal, the lubricating oil 38 is filled in the radial bearing 33, and the lubricating oil 38 is also filled in the dynamic pressure generating grooves 39 generating a dynamic pressure owing to the rotation of the rotation shaft 31. That is to say, the lubricating oil 38 is filled in all of the gaps in the housing 37.

Although the housing of the above-mentioned bearing unit 30 is made of a synthetic resin, the material is not limited to the synthetic resin. The housing may be made of a metal material such as brass, SUS and aluminum, or may be made of a synthetic resin in which these metal materials are mixed. It is noted that there is a case where the contact angle of the lubricating oil filled in the housing with the inner peripheral surface of the shaft insertion hole cannot be sufficiently maintained when the housing is made of a material other than the synthetic resin. In such a case where there is the possibility that the contact angle of the lubricating oil cannot be maintained to be large, the contact angle may be increased by coating a surface-active agent on the inner peripheral surface of the shaft insertion hole, or on the outer peripheral surface of the upper sealing portion including the inner peripheral surface of the shaft insertion hole.

Because the bearing unit 30 configured as described above performs the prevention of the slip-out of the shaft by making the locking portion formed in the upper sealing portion on the opened end side of the housing abut against the abutting portion of the rotation shaft, it is unnecessary to adopt the configuration of being equipped with the slip-out preventing member such as a washer on the bottom sealing portion side being the sealing portion side of the housing like the conventional bearing units. Consequently, the bearing unit 30 can eliminate the part of the slip-out preventing member to reduce the cost and the height of the bearing unit itself in the shaft direction. As a result, the bearing unit 30 can maintain a good lubrication performance and a rotation performance without any leakage and scattering of lubricating oil, and besides, the bearing unit 30 can settle the problems of the conventional bearing units. Then, the general versatility and the selectivity of the bearing unit can be improved, and the degree of freedom of the design of an article using the bearing unit can be improved.

Though the thrust bearing of the bearing unit 30 described above is formed as a part of the housing, the thrust bearing may be formed to be separated from the bottom sealing portion.

The bearing unit in which the thrust bearing is formed to be separated from the bottom sealing portion may be configured as shown in FIG. 11. Incidentally, in the following description, the parts common to those of the bearing unit 30 shown in FIG. 5 are denoted by common reference numerals, and detailed descriptions of them are omitted.

The bearing unit 60 shown in FIG. 11 includes the radial bearing 33 for supporting the rotation shaft 31 in the peripheral rotation direction, a thrust bearing 62 supporting one end of the rotation shaft 31 in the thrust direction, and a housing 63 accommodating the radial bearing 33 and the thrust bearing 62 therein.

The housing 63 accommodating the radial bearing 33 supporting the rotation shaft 31 has a shape of accommodating the radial bearing 33 formed in a cylinder to enclose it, as shown in FIG. 11. The housing 63 is composed of a housing main body 64, with which an upper sealing portion 66 is integrally formed, and a bottom sealing portion 65 for sealing the lower part opened portion formed on the side opposed to the upper sealing portion 66 of the housing main body 64. The housing main body 64 has a shape of a cylinder, and the upper sealing portion 66 is integrally formed on one end side thereof. The housing main body 64 and the upper sealing portion 66 are formed of a resin. A shaft insertion hole 45, through which the rotation shaft 31 rotatably supported by the radial bearing 33 accommodated in the housing 63 is inserted, is formed in the central part of the upper sealing portion 66.

A thrust bearing 62 for rotatably supporting a bearing supporting portion 31a formed at one end in the thrust direction of the rotation shaft 31 supported by the radial bearing 33 is formed in the central part of the bottom sealing portion 65 on the inner surface side thereof. The thrust bearing 62 is made of a resin. The thrust bearing 34 is formed as a pivot bearing supporting the bearing supporting portion 31a of the rotation shaft 31 at a point. The bearing supporting portion 31a is formed in a shape of a circular arc or a tapered shape.

The housing 63 configured as described above is formed by integrating the housing main body 64 accommodating the radial bearing 33 formed in a shape of a cylinder with the bottom sealing portion 65 by press fitting and/or adhesion. The housing 63 is structured in order that the inside thereof is sealed except for the shaft insertion hole 45.

The rotation shaft 31 is supported by the housing 63 in a manner, as shown in FIG. 11, such that the bearing supporting portion 31a of the rotation shaft 31 on one end side is supported by the thrust bearing 62, the outer peripheral surface of the shaft main body 31b is supported by the radial bearing 33, and the side of the attachment portion 32 provided on the other end side protrudes from the shaft insertion hole 45 formed in the upper sealing portion 66 of the housing main body 64.

A shaft slip-out preventing mechanism for preventing the rotation shaft 31 from slipping out of the radial bearing 33 and the housing 37 is provided in the peripheral portion of the shaft insertion hole 45 on the inner surface side of the housing 63 in the upper sealing portion 66 of the housing 63. As the shaft slip-out preventing mechanism, a stepwise recessed portion 51 having a step portion formed in a step is formed on the inner surface side of the shaft insertion hole 45 in the upper sealing portion 44. The stepwise recessed portion 51 is made by forming a recess in a cylinder in the peripheral portion of the shaft insertion hole 45, and includes a step portion of a step from the inner surface of the upper sealing portion toward the outside of the housing. The step portion of the stepwise recessed portion 51 locks the abutting portion 53 when the rotation shaft 31 is pulled up from the inside of the housing to prevent the rotation shaft 31 from jumping out of the housing 37. That is to say, the step portion becomes the locking portion 52 for preventing the falling off of the rotation shaft 31.

Consequently, even when the rotation shaft 31 is lifted up at the assembly thereof, or even when the rotation shaft 31 is lifted upward owing to an impact or the like, the locking portion 52 of the housing 63 abuts against the abutting portion 53 of the shaft main body 31b. Consequently, the bearing unit 60 prevents the rotation shaft 31 from slipping out of the housing 63 similarly to the case of the bearing unit 30.

A process for manufacturing the bearing unit 60, which is configured as described above and the present invention is applied to, is described.

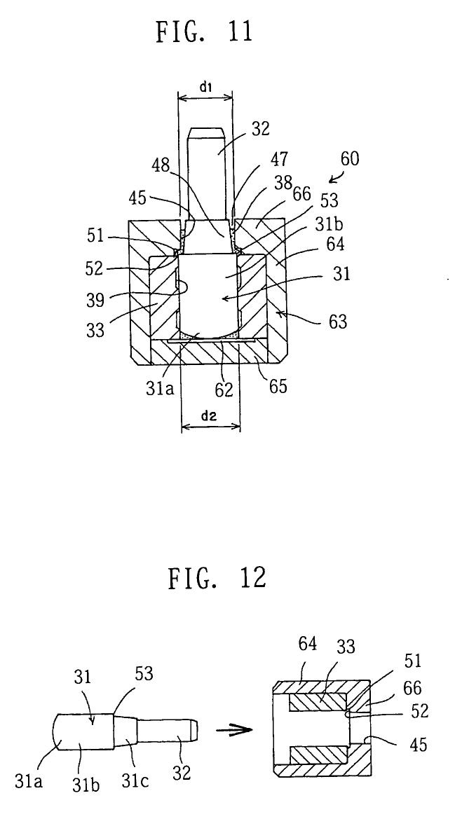

For manufacturing the bearing unit 60, as shown in FIG. 12, the rotation shaft 31 is inserted into the housing main body 64 accommodating the radial bearing 33 therein. At this time, the rotation shaft 31 is inserted from the opened portion side of the housing main body 64 in order that the side of the attachment portion 32 of the rotation shaft 31 may be first inserted. Because the inner diameter of the attachment portion 32 of the rotation shaft 31 is formed to be smaller than the inner diameter of the shaft insertion hole 45, the attachment portion 32 is inserted from the shaft insertion hole 45 to protrude to the outside of the housing 37. Then, because the outer diameter d2 of the shaft main body 31b of the rotation shaft 31 is formed to be larger than the inner diameter d1 of the shaft insertion hole 45, the shaft main body 31b does not protrude from the shaft insertion hole 45. Moreover, because the outer diameter d2 of the shaft main body 31b is formed to be smaller than the inner diameter d3 of the stepwise recessed portion 51, the abutting portion 53 of the shaft main body 31b abuts against the locking portion 52 of the stepwise recessed portion 51.

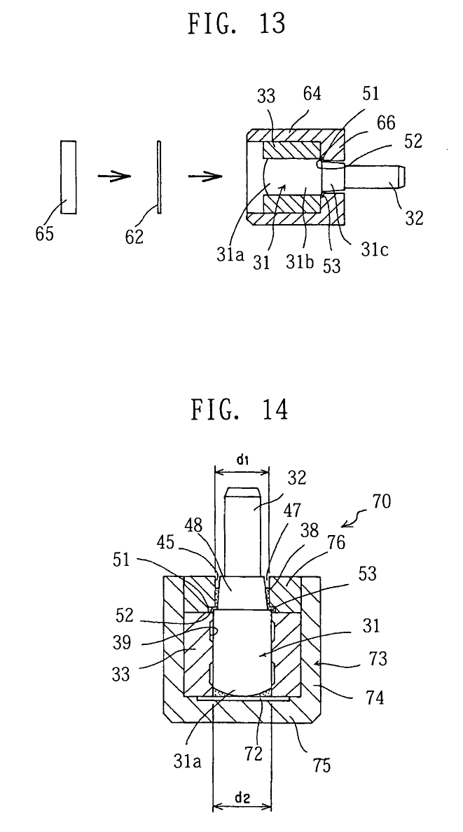

Next, as shown in FIG. 13, the thrust bearing 62 is attached from the opened portion of the housing main body 64 having accommodated the rotation shaft 31 and the radial bearing 33 to be integrated by performing the press fitting and/or adhesion of the bottom sealing portion 65 to the housing main body 64.

Then, as shown in FIG. 13, when the bottom sealing portion 65 has been press fitted and/or adhered to the housing main body 64 accommodating the rotation shaft 31 and the radial bearing 33 to be integrated, the lubricating oil 38 is filled into the housing 63. The filling of the lubricating oil 38 is performed as follows. That is, the housing 63, in which the rotation shaft 31 is inserted, is thrown into a not shown filling bath containing a lubricating oil therein. Next, the filling bath, in which the housing has been thrown in, is vacuum-sucked by a vacuum apparatus. After that, by taking out the filling bath, which has been vacuum-sucked, into the air, the lubricating oil 38 is filled into the housing 63.

Because, in the bearing unit 60, to which the present invention is applied, the radial bearing 33 is made of a sintered metal, the lubricating oil 38 is filled in the radial bearing 33, and the lubricating oil 38 is also filled in the dynamic pressure generating grooves 39 generating a dynamic pressure owing to the rotation of the rotation shaft 31. That is to say, the lubricating oil 38 is filled in all of the gaps in the housing 63.

Although the housing of the above-mentioned bearing unit 60 is made of a synthetic resin, the material of the housing is not limited to the synthetic resin. The housing may be made of a metal material such as brass, SUS and aluminum, or may be made of a synthetic resin in which these metal materials are mixed. It is noted that there is a case where the contact angle of the lubricating oil filled in the housing with the inner peripheral surface of the shaft insertion hole cannot be sufficiently maintained when the housing is made of a material other than the synthetic resin. In such a case where there is the possibility that the contact angle of the lubricating oil cannot be maintained to be large, the contact angle may be increased by coating a surface-active agent on the inner peripheral surface of the shaft insertion hole, or on the outer peripheral surface of the upper sealing portion including the inner peripheral surface of the shaft insertion hole.

Because the bearing unit 60 configured as described above performs the prevention of the slip-out of the shaft by making the locking portion formed in the upper sealing portion on the opened end side of the housing abut against the abutting portion of the rotation shaft similarly to the case of the bearing unit 30, it is unnecessary to adopt the configuration of being equipped with the slip-out preventing member such as a washer on the bottom sealing portion side being the sealing portion side of the housing like the conventional bearing units. Consequently, the bearing unit 60 can eliminate the part of the slip-out preventing member to reduce the cost and the height of the bearing unit itself in the shaft direction. As a result, the bearing unit 60 can maintain a good lubrication performance and a rotation performance without any leakage and scattering of lubricating oil, and besides the bearing unit 60 can settle the problems of the conventional bearing units. Then, the general versatility and the selectivity of the bearing unit can be improved, and the degree of freedom of the design of an article using the bearing unit can be improved.

Moreover, although the bearing unit 30 and the bearing unit 60 described above severally include the bottom sealing portion formed independent of the housing main body, the upper sealing portion may be formed independent of the housing main body, and the upper sealing portion may be integrated by being adhered to the housing main body.

The bearing unit in which the upper sealing portion is formed independent of the housing main body may be configured as shown in FIG. 14. Incidentally, in the following description, the parts common to those of the bearing unit 30 shown in FIG. 5 are denoted by common reference numerals, and detailed descriptions of them are omitted.

The bearing unit 70 shown in FIG. 14 includes the radial bearing 33 for supporting the rotation shaft 31 in the peripheral rotation direction, a thrust bearing 72 supporting one end of the rotation shaft 31 in the thrust direction, and a housing 73 accommodating the radial bearing 33 and the thrust bearing 72 therein.

The housing 73 accommodating the radial bearing 33 supporting the rotation shaft 31 has a shape of accommodating the radial bearing 33 formed in a cylinder to enclose it, as shown in FIG. 14. The housing 73 is composed of a housing main body 74, with which a bottom sealing portion 75 is integrally formed, and an upper sealing portion 76 for sealing the upper part opened portion formed on the side opposed to the bottom sealing portion 75 of the housing main body 74. The housing main body 74 has a shape of a cylinder, and the bottom sealing portion 75 is integrally formed on one end side thereof. The housing main body 74 and the bottom sealing portion 75 are formed of a resin. A shaft insertion hole 45, through which the rotation shaft 31 rotatably supported by the radial bearing 33 accommodated in the housing 73 is inserted, is formed in the central part of the upper sealing portion 76.

A thrust bearing 72 for rotatably supporting the bearing supporting portion 31a formed at one end in the thrust direction of the rotation shaft 31 supported by the radial bearing 33 is formed in the central part of the bottom sealing portion 75 of the housing main body 74 on the inner surface side thereof. The thrust bearing 72 is made of a resin. The thrust bearing 72 is formed as a pivot bearing supporting the bearing supporting portion 31a of the rotation shaft 31 at a point. The bearing supporting portion 31a is formed in a shape of a circular arc or a tapered shape.

The housing 73 configured as described above is formed by integrating the housing main body 74 accommodating the radial bearing 33 formed in a shape of a cylinder with the upper sealing portion 76 by press fitting and/or adhesion. The housing 73 is structured in order that the inside thereof is sealed except for the shaft insertion hole 45.

The rotation shaft 31 is supported by the housing 73 in the manner, as shown in FIG. 14, such that the bearing supporting portion 31a on one end side is supported by the thrust bearing 72, the outer peripheral surface of the shaft main body 31b is supported by the radial bearing 33, and the side of the attachment portion 32 provided on the other end side protrudes from the shaft insertion hole 45 formed in the upper sealing portion 76 of the housing 73.

A shaft slip-out preventing mechanism for preventing the rotation shaft 31 from slipping out of the radial bearing 33 and the housing 73 is provided in the peripheral portion of the shaft insertion hole 45 on the inner surface side of the housing 73 in the upper sealing portion 76 of the housing 73. As the shaft slip-out preventing mechanism, a stepwise recessed portion 51 having a step portion formed in a step is formed on the inner surface side of the shaft insertion hole 45 in the upper sealing portion 76. The stepwise recessed portion 51 is made by forming a recess in a cylinder in the peripheral portion of the shaft insertion hole 45, and includes a step portion of a step from the inner surface of the upper sealing portion toward the outside of the housing. The step portion of the stepwise recessed portion 51 locks the abutting portion 53 when the rotation shaft 31 is pulled up from the inside of the housing to prevent the rotation shaft 31 from jumping out of the housing 73. That is to say, the step portion becomes the locking portion 52 for preventing the falling off of the rotation shaft 31.

Consequently, even in a case where the rotation shaft 31 is lifted up at the assembly thereof, or even in a case where the rotation shaft 31 is lifted upward owing to an impact or the like, the locking portion 52 of the housing 73 abuts against the abutting portion 53 of the shaft main body 31b. Consequently, the bearing unit 70 prevents the rotation shaft 31 from slipping out of the housing 73 similarly to the cases of the bearing units 30 and 60.

A process for manufacturing the bearing unit 70, which is configured as described above and the present invention is applied to, is described.

For manufacturing the bearing unit 70, as shown in FIG. 15, the rotation shaft 31 is inserted into the housing main body 74 accommodating the radial bearing 33 and the thrust bearing 72 therein. At this time, the rotation shaft 31 is inserted from the opened portion side of the housing main body 74 in order that the side of the rotation supporting unit 31a may be first inserted.

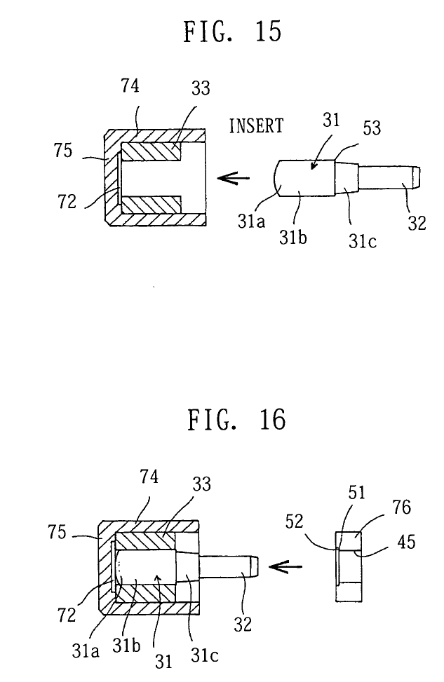

Next, as shown in FIG. 16, the upper sealing portion 76 is integrated by the press fitting and/or adhesion of the upper sealing portion 76 to the opened portion of the housing main body 74 having accommodated the rotation shaft 31, the radial bearing 33 and the thrust bearing 72 therein.

At this time, because the inner diameter of the attachment portion 32 of the rotation shaft 31 is formed to be smaller than the inner diameter d1 of the shaft insertion hole 45, the attachment portion 32 is inserted from the shaft insertion hole 45 to protrude to the outside of the housing 73. Then, because the outer diameter d2 of the shaft main body 31b of the rotation shaft 31 is formed to be larger than the inner diameter d1 of the shaft insertion hole 45, the shaft main body 31b does not protrude from the shaft insertion hole 45. Moreover, because the outer diameter d2 of the shaft main body 31b is formed to be smaller than the inner diameter d3 of the stepwise recessed portion 51, the abutting portion 53 formed on the shaft main body 31b abuts against the locking portion 52 of the stepwise recessed portion 51.

Then, as shown in FIG. 16, when the upper sealing portion 76 has been press fitted and/or adhered to the housing main body 74 accommodating the rotation shaft 31 and the radial bearing 33 to be integrated, the lubricating oil 38 is filled into the housing 73. The filling of the lubricating oil 38 is performed as follows. That is, the housing 73, in which the rotation shaft 31 is inserted, is thrown into a not shown filling bath containing a lubricating oil therein. Next, the filling bath, in which the housing has been thrown in, is vacuum-sucked by a vacuum apparatus. After that, by taking out the filling bath, which has been vacuum-sucked, into the air, the lubricating oil 38 is filled into the housing 73.

Because, in the bearing unit 70, to which the present invention is applied, the radial bearing 33 is made of a sintered metal, the lubricating oil 38 is filled in the radial bearing 33, and the lubricating oil 38 is also filled in the dynamic pressure generating grooves 39 generating a dynamic pressure owing to the rotation of the rotation shaft 31. That is to say, the lubricating oil 38 is filled in all of the gaps in the housing 73.

Although the housing of the above-mentioned bearing unit 70 is made of a synthetic resin, the material of the housing is not limited to the synthetic resin. The housing may be made of a metal material such as brass, SUS and aluminum, or may be made of a synthetic resin in which these metal materials are mixed. Incidentally, there is a case where the contact angle of the lubricating oil filled in the housing with the inner peripheral surface of the shaft insertion hole cannot be sufficiently maintained when the housing is made of a material other than the synthetic resin. In such a case where there is the possibility that the contact angle of the lubricating oil cannot be maintained to be large, the contact angle may be increased by coating a surface-active agent on the inner peripheral surface of the shaft insertion hole, or on the outer peripheral surface of the upper sealing portion including the inner peripheral surface of the shaft insertion hole.

Because the bearing unit 70 configured as described above performs the prevention of the slip-out of the shaft by making the locking portion formed in the upper sealing portion on the opened end side of the housing abut against the abutting portion of the rotation shaft similarly to the cases of the bearing units 30 and 60, it is unnecessary to adopt the configuration of being equipped with the slip-out preventing member such as a washer on the bottom sealing portion side being the sealing portion side of the housing like the conventional bearing units. Consequently, the bearing unit 70 can eliminate the part of the slip-out preventing member to reduce the cost and the height of the bearing unit itself in the shaft direction. As a result, the bearing unit 70 can maintain a good lubrication performance and a rotation performance without any leakage and scattering of lubricating oil, and besides the bearing unit 70 can settle the problems of the conventional bearing units. Then, the general versatility and the selectivity of the bearing unit can be improved, and the degree of freedom of the design of an article using the bearing unit can be improved.

Moreover, although the bearing unit 70 described above includes the thrust bearing for performing the support in the thrust direction of the shaft, which thrust bearing is formed as a pivot bearing supporting the bearing supporting portion formed on one end side of the shaft to be a shape of a circular arc or a tapering tip, the bearing unit to which the present invention is applied is not limited to one using the pivot bearing mentioned above. The bearing unit may be one performing the support by means of a bearing supporting one end of the shaft by a surface.

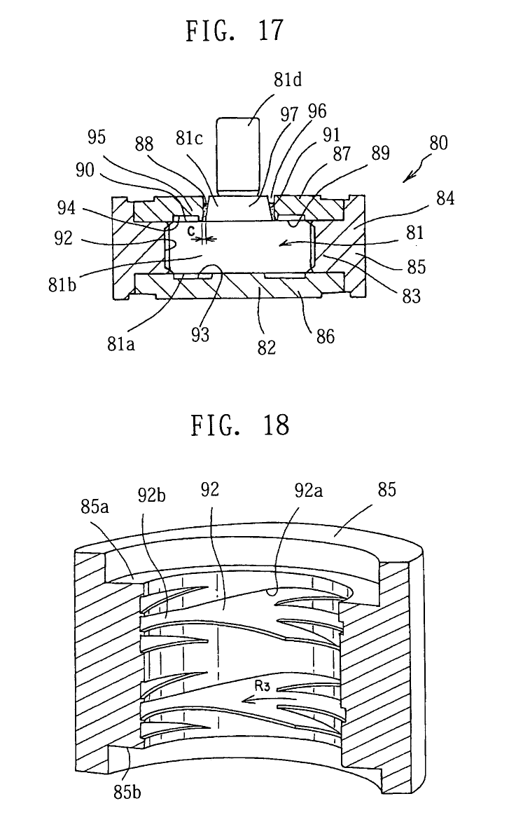

An example of the bearing unit using the thrust bearing performing the support of the shaft in the thrust direction by means of a surface is described with reference to FIG. 17. The parts common to those of the bearing unit 30 shown in FIG. 5 are denoted by common reference numerals, and detailed descriptions of them are omitted.

The bearing unit 80 shown in FIG. 17 includes a radial bearing 83 for supporting a rotation shaft 81 in the peripheral rotation direction, a first thrust bearing 82 supporting one end of the rotation shaft 81 in the thrust direction, and a housing 84 accommodating the radial bearing 83 and the first thrust bearing 82 therein.

The housing 84 is formed as a cylinder in order to accommodate the rotation shaft 81 therein, as shown in FIG. 17. The housing 84 is composed of a housing main body 85, with which the radial bearing 83 supporting the rotation shaft 81 in the peripheral rotation direction is integrally formed, a bottom sealing portion 86 formed in a disc shape to seal the bottom of the housing main body 85, and an upper sealing portion 87 formed on the side opposed to the bottom sealing portion 86. The first thrust bearing 82 supporting one end side of the rotation shaft 81 in the thrust direction is integrally formed with the bottom sealing portion 86 in the central part of the bottom sealing portion 86 on the inner surface side thereof.

An upper engaging recess 85a and a bottom engaging recess 85b for engaging with the upper sealing portion 87 and the bottom sealing portion 86, respectively, to attach both the sealing portions to the housing main body 85 are formed as disc-shaped recesses in the opened portions on both the ends of the housing main body 85.

A shaft insertion hole 88, through which an attachment portion 81d of the rotation shaft 81 is protruded from the housing 84, is formed in the upper sealing portion 87 of the housing 84. The inner diameter of the shaft insertion hole 88 is formed so that the inner diameter is larger than the outer diameter of a tapered portion 81c and is smaller than the outer diameter of a shaft main body 81b.

A shaft slip-out preventing mechanism for preventing the rotation shaft 81 from slipping out of the radial bearing 83 and the housing 84 is provided in the peripheral portion of the shaft insertion hole 88 on the inner surface side of the housing 84 in the upper sealing portion 87 of the housing 84. As the shaft slip-out preventing mechanism, a locking portion 89, which regulates the rotation shaft 31 in order not to move toward the shaft-opened side, i.e. upward, and is slidably contacted with an abutting portion 90, is formed on the peripheral portion of the shaft insertion hole 88 on the inner surface side of the upper sealing portion 87 of the housing 84.

The rotation shaft 81 rotatably supported by the radial bearing 83 and the first thrust bearing 82, both arranged in the housing 84, is formed of a bearing supporting portion 81a supported by the first thrust bearing 82, the shaft main body 81b supported by the radial bearing 83, the attachment portion 81d, to which, for example, the rotor 18 of the motor 10 being a body of rotation is attached on the other end side against the bearing supporting portion 81a, and the taper-shaped insertion portion 81c, which is formed between the shaft main body 81b and the attachment portion 81d and is opposed to the inner surface of the shaft insertion hole 88. The shaft main body 81b is formed to have a diameter larger than that of the tapered portion 81c, and a stepped portion to be the abutting portion 90 for shaft slip-out preventing is formed between the shaft main body 81b and the insertion portion 81c of the rotation shaft 81.

That is to say, the shaft main body 81b of the rotation shaft 81 is formed to have a diameter larger than those of the tapered portion 81c and the attachment portion 81d, and the slidably contacting portion 90 to slidable contact with the locking portion 89 is formed at a position opposed to the locking portion 89 on the upper surface side of the shaft main body 81b. Because the slidably contacting portion 90 of the rotation shaft 81 slidably contacts with the locking portion 89 of the upper sealing portion 87 of the housing, the slidably contacting portion 90 regulates the rotation shaft 81 to move upward. Consequently, the fall off of the rotation shaft 81 is prevented.

The radial bearing 83 is integrally formed with the housing main body 85 by forming the housing main body 85 with a sintered metal. The radial bearing 83 constitutes a dynamic pressure fluid bearing together with a lubricating oil 91 being a viscous fluid filled in the housing 84. Dynamic pressure generating grooves 92 are formed on the inner peripheral surface, through which the rotation shaft 81 is inserted.

As shown in FIG. 18, the dynamic pressure generating grooves 92 are severally configured by forming a pair of V-shaped grooves 92a on the inner peripheral surface of the radial bearing 83 to be continuous in a peripheral rotation direction with a connection groove 92b. The dynamic pressure generating grooves 92 are severally formed in order that the tip side of the pair of V-shaped grooves 92a may face toward a rotation direction R₃ of the rotation shaft 81. In the present embodiment, the pair of dynamic pressure generating grooves 92 are formed to be arranged at an upper position and a lower position in the shaft direction of the radial bearing 83 in parallel with each other. The number and the sizes of the dynamic pressure generating grooves formed on the radial bearing 83 are suitably selected according to the size, the length and the like of the radial bearing 83.

When the rotation shaft 81 inserted in the radial bearing 83 continuously rotates in the direction of the arrow R₃ in FIG. 18 around a central axis CL, the lubricating oil 91 filled in the housing 84 circulates in the dynamic pressure generating grooves 92, and the radial bearing 83 formed as the dynamic pressure fluid bearing generates a dynamic pressure between the outer peripheral surface of the rotation shaft 81 and the inner peripheral surface of the radial bearing 83 to support the rotating rotation shaft 81. The dynamic pressure generated at this time extremely reduces a friction coefficient between the rotation shaft 81 and the radial bearing 83 to realize the smooth rotation of the rotation shaft 81.

The first thrust bearing 82 is integrally formed with the bottom sealing portion 86 in the central part thereof on the inner surface side by forming the bottom sealing portion 86 with a sintered metal. The first thrust bearing 82 supports the plane-shaped bearing supporting portion 81a formed at the end of the shaft main body 81b shaped in a cylinder.

As shown in FIG. 19, on the surface opposed to the bearing supporting portion 81a of the rotation shaft 81 of the first thrust bearing 82, dynamic pressure generating grooves 93 are formed to be configured as a dynamic pressure bearing. The dynamic pressure generating grooves 93 are severally configured by forming a pair of V-shaped grooves 93a on the surface opposed to the rotation shaft of the first thrust bearing 82 to be continuous in a peripheral rotation direction with a connection groove 93b. The dynamic pressure generating grooves 93 are severally formed in order that the tip side of the pair of V-shaped grooves 93a may face toward a rotation direction R₄ of the rotation shaft 81.

When the rotation shaft 81 rotates, the lubricating oil 91 filled in the housing 84 circulates in the dynamic pressure generating grooves 93, and the first thrust bearing 82 formed as the dynamic pressure fluid bearing supports the bearing supporting portion 81a formed at one end of the rotation shaft 81 rotating while generating a dynamic pressure between the outer peripheral surface of the rotation shaft 81 and the inner peripheral surface of the radial bearing 83. The friction coefficient between the rotation shaft 81 and the first thrust bearing 82 is made to be very small, and the smooth rotation of the rotation shaft 81 can be realized.

A second thrust bearing 95 for supporting the rotation shaft 81 in the thrust direction in conjunction with the first thrust bearing 82 is formed on a surface opposed to the first thrust bearing 82 in the bearing unit 80.

The second thrust bearing 95 is formed by the support of the rotation shaft 81 in the thrust direction by the locking portion 89 formed in the upper sealing portion 87 of the housing 84 to be slidably contacted with the abutting portion 90 formed on the upper surface of the shaft main body Bib of the rotation shaft 81.

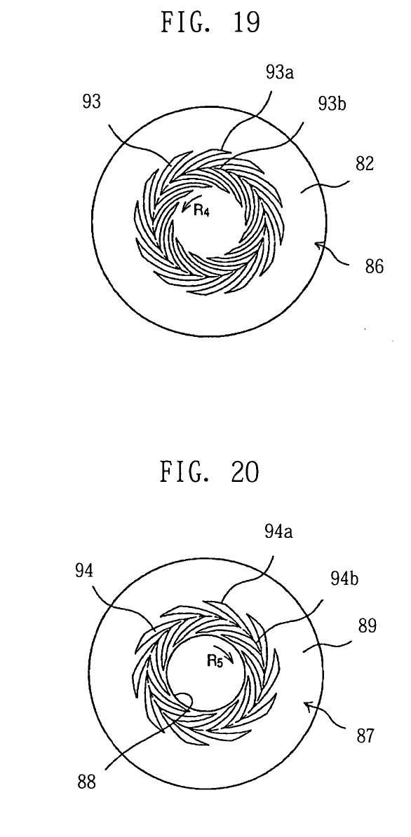

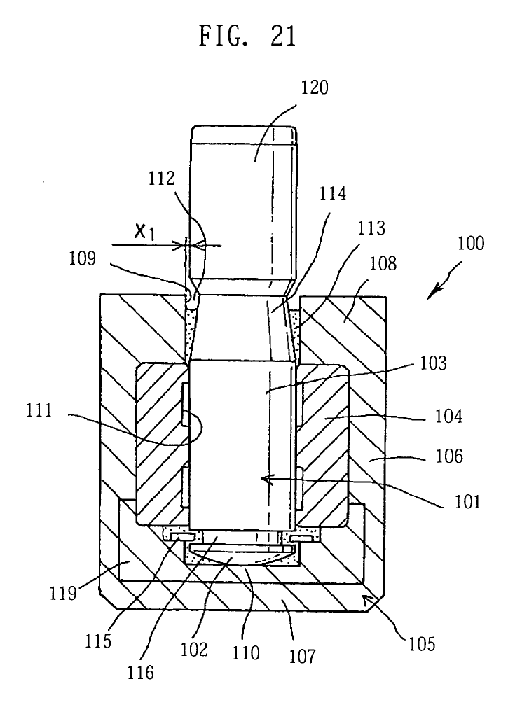

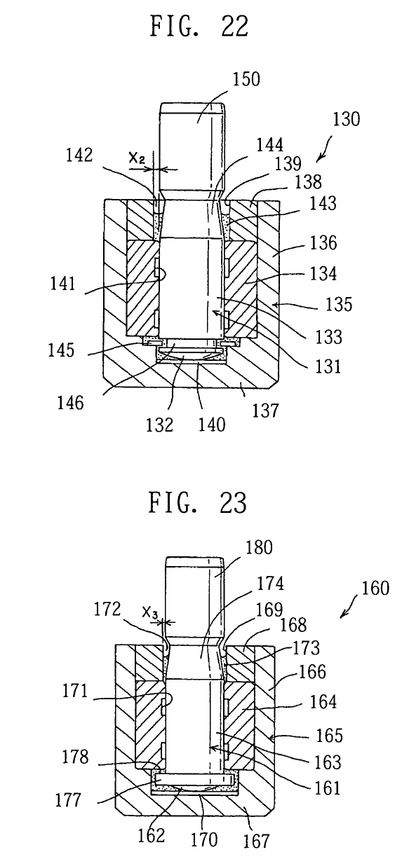

On a surface of the locking portion 89 formed in the upper sealing portion 87, which surface is opposed to the slidably contacting portion 90 of the rotation shaft 81, as shown in FIG. 20, dynamic pressure generating grooves 94 are formed to be configured as a dynamic pressure bearing. The dynamic pressure generating grooves 94 are severally configured by forming a pair of V-shaped grooves 94a on the surface opposed to the rotation shaft 81 of the locking portion 89 to be continuous in a peripheral rotation direction with a connection groove 94b. The dynamic pressure generating grooves 94 are severally formed in order that the tip side of the pair of V-shaped grooves 94a may face toward a rotation direction R₅ of the rotation shaft 81.

Moreover, because in the bearing unit 80 the rotation shaft 81 is supported by the radial bearing 83, the first thrust bearing 82 and the second thrust bearing 95, a stable rotation can be realized. In particular, in the present embodiment, because the radial bearing 83, the first thrust bearing 82 and the second thrust bearing 95 are formed by means of dynamic pressure fluid bearings, the rotation shaft 81 rotates, being supported by the radial bearing 82, the first thrust bearing 83 and the second thrust bearing with the lubricating oil 91. Consequently, the generation of sliding sounds and vibrations caused by slidable contact with a bearing can be suppressed, and the extremely low noise bearing unit 80 can be configured. Moreover, because the thrust bearing 82 is formed to have a diameter larger than that of the attachment portion 81d of the rotation shaft 81, stable support of the rotation shaft 81 can be realized.

Incidentally, the radial bearing 83 and the first thrust bearing 82 are formed integrally with the housing main body 85 and the bottom sealing portion 86, and made of a sintered metal. However, the material is not limited to the sintered metal, but brass, stainless or a high polymer material may be adopted.

Now, the shaft insertion hole 88 of the housing 84 is formed to have an inner diameter slightly larger than the outer diameter of the insertion portion 81c of the rotation shaft 81 in order that the insertion portion 81c of the rotation shaft 81 being a part to be inserted into the shaft insertion hole 88 rotates without slidable contacting with the inner peripheral surface of the shaft insertion hole 88. In this case, the shaft insertion hole 88 is formed to have a gap 96 of the space c sufficient for preventing the lubricating oil 91 filled in the housing 84 from leaking from the housing 84 between the inner peripheral surface of the shaft insertion hole 88 and the outer peripheral surface of the insertion portion 81c of the rotation shaft 81. The upper sealing portion 87 forming the shaft insertion hole 88 in order that the gap 96 for preventing the leakage of the lubricating oil 91 filled in the housing 84 between the shaft insertion hole 88 and the rotation shaft 81 in the way described above constitutes an oil seal portion.

Moreover, a tapered portion 97 is formed on the outer peripheral surface of the rotation shaft 81 opposed to the inner peripheral surface of the shaft insertion hole 88. The tapered portion 97 inclines in a manner of enlarging the gap 96 formed between the outer peripheral surface of the rotation shaft 81 and the inner peripheral surface of the shaft insertion hole 88 toward the outside of the housing 84. The tapered portion 97 forms a pressure gradient in the gap 96 formed between the outer peripheral surface of the rotation shaft 81 and the inner peripheral surface of the shaft insertion hole 88, and a force drawing the lubricating oil 91 filled in the housing 84 into the inside of the housing 84. Because the lubricating oil 91 is drawn in the inside of the housing 84 at the rotation of the rotation shaft 81, the lubricating oil 91 surely permeates the dynamic pressure generation grooves 92 of the radial bearing 83 made as a dynamic pressure fluid bearing to generate a dynamic pressure. Thereby, a stable support of the rotation shaft 81 is realized, and the leakage of the lubricating oil 91 filled in the housing 84 can be prevented.

In the bearing unit 80, to which the present invention is applied, the gap 96 formed between the outer peripheral surface of the rotation shaft 81 and the inner peripheral surface of the shaft insertion hole 88 prevents the scattering of the lubricating oil 91 by a surface tension seal similarly to the case of the bearing unit 30.

Moreover, in the bearing unit 80, similarly to the bearing unit 30, the tapered portion 97 inclines in a manner of reducing the space c of the gap 96 formed between the outer peripheral surface of the rotation shaft 81 and the inner peripheral surface of the shaft insertion hole 88, which gap 96 constitutes a sealing portion for preventing the leakage of the lubricating oil 91 filled in the housing 84 to the outside of the housing 84, toward the inside of the housing 84. Consequently, the tapered portion 97 forms a pressure gradient in the lubricating oil 91 located in the gap 96 formed between the outer peripheral surface of the rotation shaft 81 and the inner peripheral surface of the shaft insertion hole 88. That is to say, the pressure gradient given to the lubricating oil 91 becomes larger toward the inside of the housing 84 where the space c of the gap 96 becomes smaller. By the fact that the pressure gradient is generated in the lubricating oil 91, the lubricating oil 92 always receives a pressure to draw the lubricating oil 92 in the inside of the housing 84. Consequently, even in a case where the rotation shaft 81 rotates, the air is not involved into the lubricating oil 91 located in the gap 96.

Moreover, the formation of the tapered portion 97 as described above can not only prevent the scattering of the lubricating oil 91 having permeated in the gap 96 formed between the outer peripheral surface of the rotation shaft 81 and the inner peripheral surface of the shaft insertion hole 88 to the outward of the housing 84 at the time when the rotation shaft 81 is eccentric to the shaft insertion hole 88 formed in the housing 84, but also can permeate the lubricating oil 91 over the whole circumference of the rotation shaft 81, and can prevent the exhaustion of the lubricating oil 91 around the rotation shaft 81 to ensure the stable rotation of the rotation shaft 81.

For manufacturing the bearing unit 80, to which the present invention is applied, the housing main body 85 in which the radial bearing 83 is integrally formed and the bottom sealing portion 86 in which the first thrust bearing 82 is integrally formed are welded, and the rotation shaft 81 is accommodated in the inside of the welded housing main body. Then, while the attachment portion 81d of the rotation shaft 81 accommodated in the housing main body 85 and the bottom sealing portion 86 is inserted into the shaft insertion hole 88, the upper sealing portion 87 in which the second thrust bearing 95 is integrally formed is welded to the housing main body 85.

Then, when the housing main body 85, the bottom sealing portion 86 and the upper sealing portion 87 have been integrated in the state of accommodating the rotation shaft 81, the lubricating oil 91 is filled into the housing 84. The filling of the lubricating oil 91 is performed as follows. That is, the housing 84 in which the rotation shaft 81 is inserted is thrown into a not shown filling bath containing a lubricating oil therein. Next, the filling bath in which the housing has been thrown in is vacuum-sucked by a vacuum apparatus. After that, by taking out the filling bath which has been vacuum-sucked into the air, the lubricating oil 91 is filled into the housing 84.

By performing the filling of the lubricating oil 91 into the housing 84 by vacuum-sucking by means of the vacuum apparatus, the housing 84 takes a state in which the pressure in the inside of the housing 84 is lower the pressure of the outside. As a result, it is easily prevented that the lubricating oil 91 is leaked from the housing 84.

Because in the bearing unit 80, to which the present invention is applied, the radial bearing 83, the first thrust bearing 82 and the second thrust bearing 95 are made of a sintered metal, the lubricating oil 91 is filled in the radial bearing 83, and the lubricating oil 91 is also filled in the dynamic pressure generating grooves 92, 93 and 94 generating a dynamic pressure owing to the rotation of the rotation shaft 81. That is to say, the lubricating oil 91 is filled in all of the gaps in the housing 84.

Because the bearing unit 80 configured as described above performs the shaft slip-out prevention by making the locking portion formed in the upper sealing portion on the opened end side of the housing against the abutting portion of the rotation shaft, it is unnecessary to adopt the constitution of being provided with the slip-out preventing member such as a washer on the bottom sealing portion side, or the sealing portion side of the housing like the conventional bearing units. Consequently, the bearing unit 80 can reduce the part of the slip-out preventing member to reduce the cost thereof, and to reduce the height of the bearing unit itself in the shaft direction. Moreover, the bearing unit 80 can realize the stable support of the rotation shaft by being provided with the first and the second thrust bearings, and further can reduce the length of the radial bearing in the shaft direction by supporting the radial bearing from the upper and the lower sides of the shaft main body of the rotation shaft. The height of the bearing unit itself in the shaft direction can be reduced. As a result, the bearing unit 80 can maintain a good lubricating property and a rotation property without any leakage and scattering of the lubricating oil, and the problems of the conventional bearing units can be settled. The general versatility and the selectivity of the bearing unit can be improved, and the degree of freedom of the design of an article using the bearing unit can be improved.

The bearing units described above use the lubricating oil as the viscous fluid to be filled in the housing. However, as long as a fluid having a fixed viscosity and a fixed surface tension, various viscous fluids can be suitably selected.

The bearing unit to which the present invention is applied can be used not only as a bearing for a motor of a heat radiator or a spindle motor of a disk drive but also as a bearing of various motors.

Moreover, the bearing unit to which the present invention is applied can be used not only in a motor but also widely in a mechanism having a rotating shaft or a mechanism supporting a member rotation with regard to a shaft.

1. A bearing unit comprising:
a shaft;
a radial bearing for supporting a peripheral rotation direction of said shaft;
a thrust bearing for supporting one end of said shaft in a thrust direction;
a housing having said radial bearing and said thrust bearing, both arranged therein, and being formed in a structure being sealed except for a shaft insertion hole, through which said shaft is inserted; and
a viscous fluid to be filled in said housing, wherein:
a locking portion for preventing shaft slip-out is provided on an inner surface side of said housing, which is a peripheral portion of the shaft insertion hole, in a state of abutting a part of said shaft.

2. The bearing unit as claimed in claim 1, wherein:
said shaft insertion hole of said housing is provided with a stepwise recessed portion, and
said locking portion is a step portion provided in said stepwise recessed portion.

3. The bearing unit as claimed in claim 2, wherein:
said shaft is provided with an abutting portion which regulates movement of said shaft in a shaft direction by being locked by said locking portion, and
an outer diameter of said abutting portion of said shaft is larger than an inner diameter of said shaft insertion hole and is smaller than an inner diameter of said stepwise recessed portion.

4. The bearing unit as claimed in claim 1, wherein:
said shaft is provided with an abutting portion which is slidably contacted with said locking portion of said housing,
said radial bearing is provided with, on an inner peripheral surface thereof opposing an outer peripheral surface of said shaft, a first dynamic pressure generating groove which generates a dynamic pressure caused by said viscous fluid,
said thrust bearing is provided with, on a surface opposing one end of said shaft in a thrust direction, a second dynamic pressure generating groove which generates a dynamic pressure caused by said viscous fluid, and
said locking portion is provided with, on a surface opposing said abutting portion, a third dynamic pressure generating groove which generates a dynamic pressure caused by said viscous fluid.

5. A motor having a bearing unit supporting a rotor rotatably to a stator, wherein:
said bearing unit comprises:
a shaft;
a radial bearing for supporting a peripheral rotation direction of said shaft;
a thrust bearing for supporting one end of said shaft in a thrust direction;
a housing having said radial bearing and said thrust bearing, both arranged therein, and being formed in a structure being sealed except for a shaft insertion hole, through which said shaft is inserted; and
a viscous fluid to be filled in said housing, wherein:
an abutting portion abutting said shaft, for preventing shaft from slipping-out from said housing, is provided at a sealing portion of said housing on a shaft-insertion side on which the shaft insertion hole is provided.

6. An electronic device including a motor having a bearing unit supporting a rotor rotatably to a stator, wherein:
said bearing unit comprises:
a shaft;
a radial bearing for supporting a peripheral rotation direction of said shaft;
a thrust bearing for supporting one end of said shaft in a thrust direction;
a housing having said radial bearing and said thrust bearing, both arranged therein, and being formed in a structure being sealed except for a shaft insertion hole, through which said shaft is inserted; and
a viscous fluid to be filled in said housing, wherein:
an abutting portion abutting said shaft, for preventing shaft from slipping-out from said housing, is provided at a sealing portion of said housing on a shaft-insertion side on which the shaft insertion hole is provided.
